(19) United States
(12) Patent Application Publication
(10) Pub. No.: US 2026/0105878 A1
(43) Pub. Date: Apr. 16, 2026

(54) IMAGE DISPLAY APPARATUS

(71) Applicant: LG ELECTRONICS INC., Seoul (KR)

(72) Inventors: Seunghun Baek, Seoul (KR); Mounghwan Choi, Seoul (KR); Jinhaeng Jang, Seoul (KR)

(73) Assignee: LG ELECTRONICS INC., Seoul (KR)

(21) Appl. No.: 19/355,011

(22) Filed: Oct. 10, 2025

(30) Foreign Application Priority Data
Oct. 14, 2024 (KR) PCT/KR2024/015509

(51) Int. Cl. G09G 3/20; H02J 50/10; H02J 50/90; G09G 3/3208

(52) U.S. Cl. CPC G09G 3/2092; H02J 50/10; H02J 50/90; G09G 3/3208; G09G 2320/06; G09G 2330/021; G09G 2330/027; G09G 2354/00; G09G 2370/16

(57) ABSTRACT

An image display apparatus according to an embodiment of the present disclosure includes a wireless power transmission device, a wireless power reception device to receive wireless power, a dc/dc converter to convert a first DC voltage to a display driving voltage, a controller to control the dc/dc converter, and a display to operate based on the display driving voltage, wherein the dc/dc converter includes first to fourth switching elements, and the controller is configured to operate in a phase shift mode and turn on overlap a portion of turn-on period of the first switching element and the fourth switching element while operating in a phase shift mode in an overlapping turn-on period, and change the overlapping portion increase or decrease the overlapping turn-on period of the first switching element and the fourth switching element based on a level of the first DC voltage.

### CROSS-REFERENCE TO RELATED APPLICATIONS

This application claims priority to PCT Application No. PCT/KR2024/015509, filed on October 14, 2024, the entire contents of which are hereby expressly incorporated by reference into the present application.

### BACKGROUND

### 1. Field

The present disclosure relates to an image display apparatus, and more specifically, to an image display apparatus stably displaying images based on wireless power transmission.

### 2. Description of the Related Art

With the increase in image resolution and the increase in image sharpness, the display resolution or peak luminance of a display in an image display apparatus is increasing. Also, as the panel size, display resolution or peak luminance of a display increases, the consumption of power supplied to the display becomes higher.

### SUMMARY

An object of the present disclosure is to provide an image display apparatus capable of stably displaying images based on wireless power transmission.

Another object of the present disclosure is to provide an image display apparatus capable of stably displaying images in response to a variation in a DC voltage received by a wireless power reception device.

To achieve these and other advantages and in accordance with the purpose of the present invention, as embodied and broadly described herein, the present invention provides in one aspect an image display apparatus including a wireless power transmission device configured to wirelessly transmit power, a wireless power reception device configured to receive wireless power from the wireless power transmission device, a dc/dc converter configured to convert a first DC voltage from the wireless power reception device and output a display driving voltage, a controller configured to control the dc/dc converter, and a display configured to operate based on the display driving voltage, wherein the dc/dc converter includes a first switching element and a second switching element connected in series with each other in a first leg, and a third switching element and a fourth switching element connected in series with each other in a second leg connected in parallel with the first leg, wherein the controller is configured to overlap a portion of turn-on period of the first switching element and the fourth switching element while operating in a phase shift mode, and change the overlapping portion in the turn-on period of the first switching element and the fourth switching element based on a level of the first DC voltage.

The controller controls the first switching element and the second switching element to switch complementarily and the third switching element and the fourth switching element to switch complementarily. In addition, in response to the first DC voltage being at a first level, the controller controls the overlapping portion in the turn-on period of the first switching element and the fourth switching element to be a first period, and in response to the first DC voltage being at a second level higher than the first level, the controller controls the overlapping portion to be a second period less than the first period.

Further, the controller can increase the overlapping portion in the turn-on period of the first switching element and the fourth switching element as the level of the first DC voltage decreases while operating in the phase shift mode. The controller can also, in response to a level of the display driving voltage being a third level, control the overlapping portion in the turn-on period of the first switching element and the fourth switching element to be a third period, and control the overlapping portion in the turn-on period of the first switching element and the fourth switching element to be a fourth period greater than the third period in response to the level of the display driving voltage being a fourth level higher than the third level.

The controller can also increase the overlapping portion in the turn-on period of the first switching element and the fourth switching element as the level of the display driving voltage increases. Further, the controller an control the overlapping portion in the turn-on period of the first switching element and the fourth switching element to be a fifth period in response to a distance between the wireless power transmission device and the wireless power reception device being a first distance, and control the overlapping portion in the turn-on period of the first switching element and the fourth switching element to be a sixth period greater than the fifth period in response to the distance between the wireless power transmission device and the wireless power reception device being a second distance greater than the first distance.

The controller can also increase the overlapping portion in the turn-on period of the first switching element and the fourth switching element as the distance between the wireless power transmission device and the wireless power reception device increases.

The controller can also operate the phase shift mode in response to the level of the first DC voltage being equal to or higher than a reference level, and in response to the level of the first DC voltage being lower than the reference level, control the turn-on period of the first switching element and the fourth switching element to completely overlap.

The controller can also change a switching frequency of the first switching element to the fourth switching element, operate the phase shift mode in response to the switching frequency being equal to or higher than a reference frequency, and in response to the switching frequency being lower than the reference frequency, control the turn-on period of the first switching element and the fourth switching element to completely overlap.

In addition, the controller can increase the reference frequency as the level of the display driving voltage decreases, and change the switching frequency of the first switching element to the fourth switching element within a first range, and operate the phase shift mode in response to the switching frequency being equal to or higher than a reference frequency within the first range.

Further, the controller can control the first switching element to the fourth switching element to perform zero voltage switching, and operate the phase shift mode while the first switching element to the fourth switching element performs the zero voltage switching.

The controller can also control the first switching element to the fourth switching element to perform zero voltage switching, and change wireless power transmitted from the wireless power transmission device based on the zero voltage switching.

In addition, the controller can control a power to be turned off in response to the level of the first DC voltage being less than a lower limit level or exceeds an upper limit level.

In addition, the image display apparatus according to an embodiment of the present disclosure can further include a signal processing device configured to output an image signal to the display, and the controller can output a first display driving voltage in response to an image output mode of the signal processing device being an eco mode or a standard mode, and output a second display driving voltage higher than the first display driving voltage in response to the image output mode of the signal processing device being a movie mode or a game mode.

Further, the controller can output a third display driving voltage higher than the second display driving voltage in response to the image output mode of the signal processing device being a high dynamic range mode.

The wireless power transmission device can also form magnetic fields for wireless power to the wireless power reception device and control strengths of the magnetic fields such that the strengths are greater in a side region than in a central area.

The dc/dc converter can further include a transformer of which input terminal is connected to output terminals of the plurality of switching elements, and a rectifier disposed at the output terminal of the transformer. The dc/dc converter can also include a multi-level voltage output circuit connected to an output terminal of the rectifier and configured to output a plurality of display driving voltages based on a plurality of display modes.

In accordance with another aspect of the present disclosure, of the present disclosure provides an image display apparatus including a wireless power transmission device configured to wirelessly transmit power, a wireless power reception device configured to wirelessly receive power from the wireless power transmission device, a dc/dc converter including a plurality of switching elements and configured to convert a first DC voltage from the wireless power reception device and output a display driving voltage, a controller configured to control the dc/dc converter, and a display configured to operate based on the display driving voltage, wherein the controller is configured to perform a phase shift mode in response to variation in the first DC voltage, and change an overlapping portion in turn-on period of some of the plurality of switching elements based on a level of the first DC current voltage while operating in the phase shift mode.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating an image display apparatus according to an embodiment of the present disclosure;

FIG. 2 is a block diagram of the image display apparatus;

FIG. 3 is a block diagram of a signal processing device of FIG. 2;

FIG. 4A is a diagram illustrating a method of controlling a remote controller of FIG. 2;

FIG. 4B is a block diagram of the remote controller of FIG. 2;

FIG. 5 is a block diagram of a display of FIG. 2;

FIGS. 6A and 6B are overviews illustrating an organic light-emitting panel of FIG. 5;

FIG. 7 is a block diagram of an image display apparatus according to an embodiment of the present disclosure;

FIG. 8 is another block diagram of an image display apparatus according to an embodiment of the present disclosure;

FIGS. 9A to 14C are diagrams referenced in descriptions of FIGS. 7 and 8;

FIG. 15 is an exemplary flowchart illustrating an operation method of a wireless power transmission device and a wireless power reception device according to an embodiment of the present disclosure;

FIG. 16 is a diagram referenced in description of FIG. 15;

FIG. 17 is a diagram illustrating an image display apparatus according to another embodiment of the present disclosure; and

FIG. 18 is an exemplary internal block diagram of the image display apparatus of FIG. 17.

### DETAILED DESCRIPTION OF THE EMBODIMENTS

Hereinafter, the present disclosure will be described in detail with reference to the accompanying drawings. Regarding constituent elements used in the following description, suffixes “module” and “unit” are given only in consideration of ease in the preparation of the specification, and do not have or serve as different meanings. Accordingly, the suffixes “module” and “unit” can be used interchangeably.

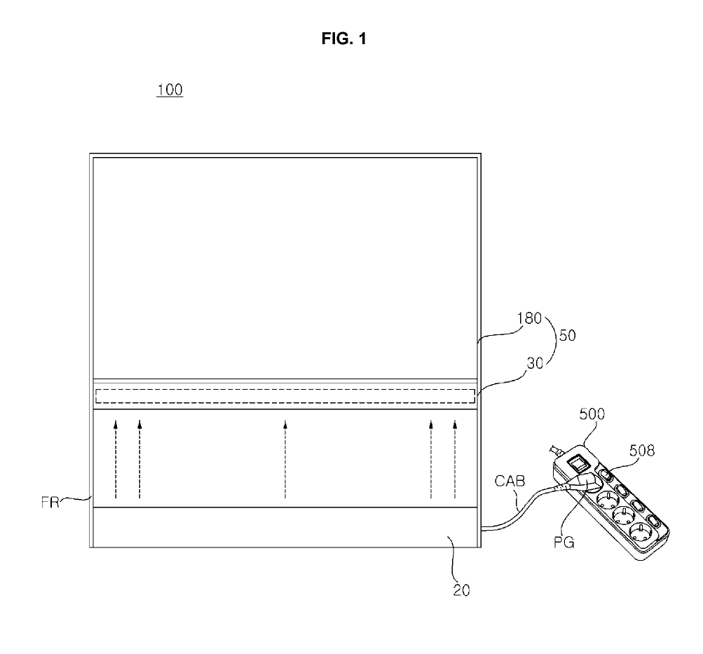

FIG. 1 is a diagram illustrating an image display apparatus 100 operating based on wireless power transmission according to an embodiment of the present disclosure. As shown, the image display apparatus 100 includes a wireless power transmission device 20 that wirelessly transmits power, a wireless power reception device 30 that wirelessly receives power from the wireless power transmission device 20, and a display 180.

The wireless power transmission device 20 is spaced apart from the wireless power reception device 30 and can transmit wireless power by magnetic induction. In FIG. 1, the wireless power transmission device 20 is disposed under a support frame FR, and the wireless power reception device 30 is disposed above the wireless power transmission device 20 and spaced apart from the wireless power transmission device 20.

That is, the wireless power transmission device 20 can be disposed under the display 180. In addition, the wireless power transmission device 20 and the display 180 are provided in a display apparatus 50, and the display apparatus 50 can be supported by the support frame FR. The wireless power transmission device 20 can be electrically connected to a power inlet that supplies an AC voltage or a multi-tap 500 connected to the power inlet through a power cable CAB and a plug PG.

In FIG. 1, the wireless power transmission device 20 is electrically connected to the multi-tap 500 connected to the power inlet through the power cable CAB and the plug PG. When a switch 508 in the multi-tap 500 is turned on, an input AC voltage Va is supplied to the wireless power transmission device 20, and when the switch 508 in the multi-tap 500 is turned off, supply of the input AC voltage Va to the wireless power transmission device 20 is stopped. Alternatively, the input AC voltage Va can be constantly supplied to the wireless power transmission device 20.

In addition, the display 180 can be implemented by one of various panels. For example, the display 180 can be one of a liquid crystal display panel (LCD panel), an organic light-emitting panel (OLED panel), and an inorganic light-emitting panel (LED panel). The image display apparatus 100 of FIG. 1 can also be a TV, a monitor, a signage display, or the like.

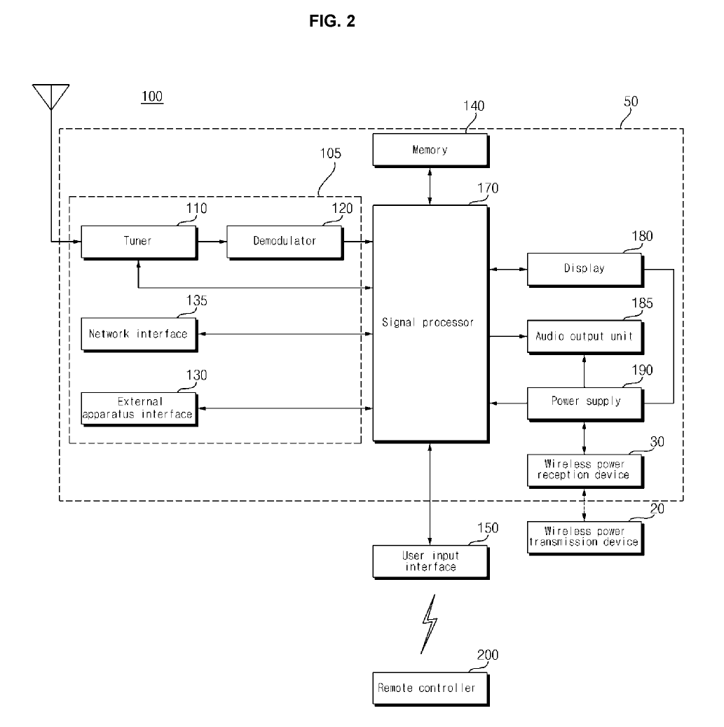

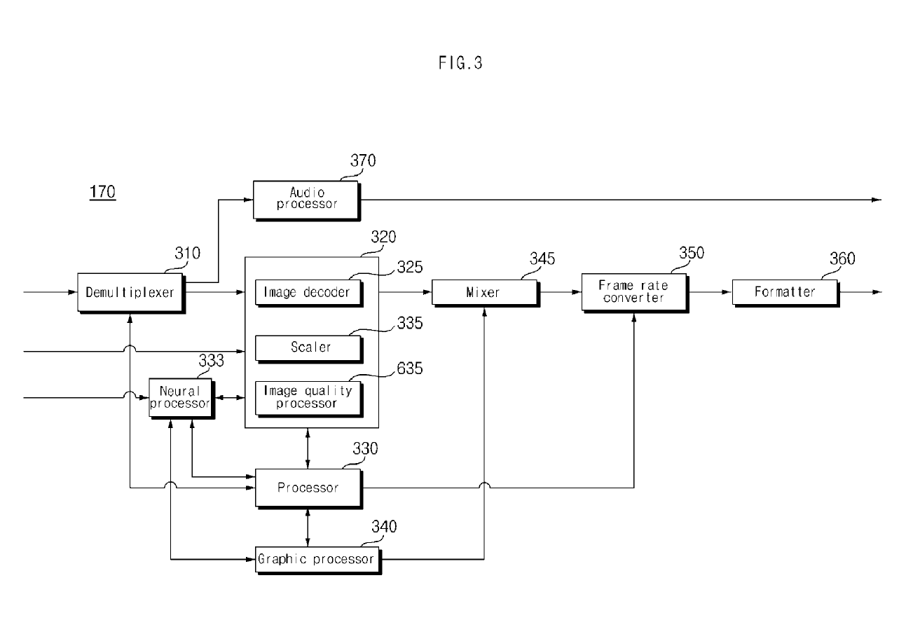

Next, FIG. 2 is a block diagram of the image display apparatus of FIG. 1. Referring to FIG. 2, the image display apparatus 100 includes the wireless power transmission device 20 that wirelessly transmits power, the wireless power reception device 30 that wirelessly receives power from the wireless power transmission device 20, the display 180, and a power supply 190.

As shown in FIG. 2, the image display apparatus 100 also includes an image receiver 105, an external apparatus interface 130, a memory 140, a user input interface 150, a signal processing device 170, and an audio output device 185. The image receiver 105 can include a tuner 110, a demodulator 120, a network interface 135, and an external apparatus interface 130. The image display apparatus 100 can also include a sensor device. Alternatively, the image receiver 105 can include only the tuner 110, the demodulator 120, and the external apparatus interface 130. That is, the network interface 135 may not be included.

The tuner 110 selects an RF broadcast signal corresponding to a channel selected by a user or all pre-stored channels among radio frequency (RF) broadcast signals received through an antenna. In addition, the selected RF broadcast signal is converted into an intermediate frequency signal, a baseband image, or an audio signal.

For example, if the selected RF broadcast signal is a digital broadcast signal, the tuner 110 converts the digital broadcast signal into a digital IF (DIF) signal, and if the selected RF broadcast signal is an analog broadcast signal, the tuner 110 converts the analog broadcast signal into an analog baseband image or voice (CVBS/SIF) signal. That is, the tuner 110 can process a digital broadcast signal or an analog broadcast signal. The analog baseband image or voice (CVBS/SIF) signal output from the tuner 110 can also be directly input to the signal processing device 170.

For example, if the selected RF broadcast signal is a digital broadcast signal, the tuner 110 converts the digital broadcast signal into a DIF signal and, if the selected RF broadcast signal is an analog broadcast signal, the tuner 110 converts the analog broadcast signal into a CVBS/SIF signal. That is, the tuner 110 can process a digital broadcast signal or an analog broadcast signal. The CVBS/SIF signal output from the tuner 110 can be directly input to the signal processing device 170.

Further, the tuner 110 can include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation. The demodulator 120 can perform demodulation and channel decoding and then output a stream signal TS. Also, the stream signal can be a multiplexed signal of an image signal, an audio signal, or a data signal.

In addition, the stream signal output from the demodulator 120 can be input to the signal processing device 170. The signal processing device 170 performs demultiplexing, image/audio signal processing, and the like, and then outputs an image to the display 180 and output audio to the audio output device 185.

Also, the external apparatus interface 130 can transmit or receive data with a connected external apparatus, e.g., a set-top box 50. Further, the external apparatus interface 130 can include an A/V input and output device. The external apparatus interface 130 can be connected in wired or wirelessly to an external apparatus, such as a digital versatile disk (DVD), a Blu ray, a game equipment, a camera, a camcorder, a computer (note book), and a set-top box, and can perform an input/output operation with an external apparatus.

The A/V input and output device can receive image and audio signals from an external apparatus. A wireless transceiver can perform short-range wireless communication with other electronic apparatus. Through the wireless transceiver, the external apparatus interface 130 can exchange data with an adjacent mobile terminal 600. In particular, in a mirroring mode, the external apparatus interface 130 can receive device information, executed application information, application image, and the like from the mobile terminal 600.

In addition, the network interface 135 provides an interface for connecting the image display apparatus 100 to a wired/wireless network including the Internet network. For example, the network interface 135 can receive, via the network, content or data provided by the Internet, a content provider, or a network operator. The network interface 135 can also include a wireless transceiver.

Further, the memory 140 can store a program for each signal processing and control in the signal processing device 170, and can store signal-processed image, audio, or data signal. In addition, the memory 140 can serve to temporarily store image, audio, or data signal input to the external apparatus interface 130 and can also store information on a certain broadcast channel through a channel memory function, such as a channel map. Although FIG. 2 illustrates that the memory is provided separately from the signal processing device 170, the memory 140 can be included in the signal processing device 170.

Further, the user input interface 150 transmits a signal input by the user to the signal processing device 170 or transmits a signal from the signal processing device 170 to the user. For example, the user input interface 150 can transmit/receive a user input signal, such as power on/off, channel selection, screen setting, etc., from a remote controller 200, can transfer a user input signal input from a local key, such as a power key, a channel key, a volume key, a set value, etc., to the signal processing device 170, can transfer a user input signal input from a sensor device that senses a user's gesture to the signal processing device 170, or can transmit a signal from the signal processing device 170 to the sensor device.

Also, the signal processing device 170 can demultiplex the input stream through the tuner 110, the demodulator 120, the network interface 135, or the external apparatus interface 130, or process the demultiplexed signals to generate and output a signal for image or audio output. For example, the signal processing device 170 receives a broadcast signal received by the image receiver 105 or an HDMI signal, and performs signal processing based on the received broadcast signal or the HDMI signal to thereby output a processed image signal.

The image signal processed by the signal processing device 170 is input to the display 180, and can be displayed as an image corresponding to the image signal. In addition, the image signal processed by the signal processing device 170 can be input to the external output apparatus through the external apparatus interface 130.

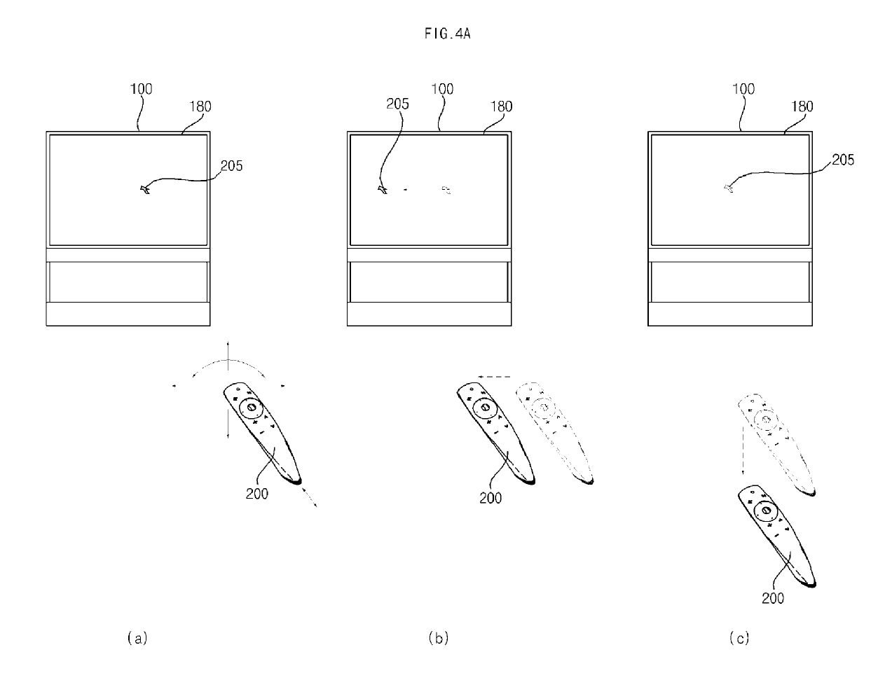

Further, the audio signal processed by the signal processing device 170 can be output to the audio output device 185 as an audio signal. In addition, audio signal processed by the signal processing device 170 can be input to the external output apparatus through the external apparatus interface 130. Also, the signal processing device 170 can include a demultiplexer, an image processor, and the like. That is, the signal processing device 170 can perform a variety of signal processing and thus can be implemented in the form of a system on chip (SOC). This will be described later with reference to FIG. 3.

In addition, the signal processing device 170 controls the overall operation of the image display apparatus 100. For example, the signal processing device 170 controls the tuner 110 to control the tuning of the RF broadcast corresponding to the channel selected by the user or the previously stored channel.

In addition, the signal processing device 170 can control the image display apparatus 100 according to a user command input through the user input interface 150 or an internal program. Meanwhile, the signal processing device 170 can control the display 180 to display an image. Also, the image displayed on the display 180 can be a still image or a moving image, and can be a 2D image or a 3D image.

Further, the signal processing device 170 can display a certain object in an image displayed on the display 180. For example, the object can be at least one of a connected web screen (newspaper, magazine, etc.), an electronic program guide (EPG), various menus, a widget, an icon, a still image, a moving image, and a text.

Also, the signal processing device 170 can recognize the position of the user based on the image photographed by a photographing device. For example, the distance (z-axis coordinate) between a user and the image display apparatus 100 can be determined. In addition, the x-axis coordinate and the y-axis coordinate in the display 180 corresponding to a user position can be determined.

Further, the display 180 generates a driving signal by converting an image signal, a data signal, an OSD signal, a control signal processed by the signal processing device 170, an image signal, a data signal, a control signal, and the like received from the external apparatus interface 130. Also, the display 180 can be configured as a touch screen and used as an input device in addition to an output device.

Further, the audio output device 185 receives a signal processed by the signal processing device 170 and outputs audio. Also, a photographing device photographs a user and can be implemented by a single camera, or by a plurality of cameras. Image information photographed by the photographing device can be input to the signal processing device 170.

Further, the signal processing device 170 can sense a gesture of the user based on each of the images photographed by the photographing device, the signals detected from the sensor device, or a combination thereof.

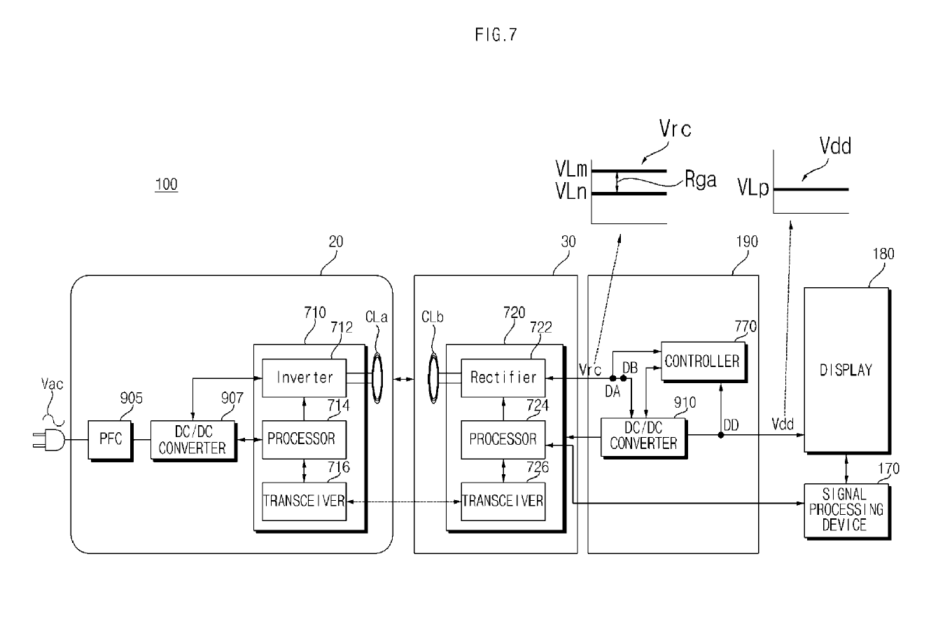

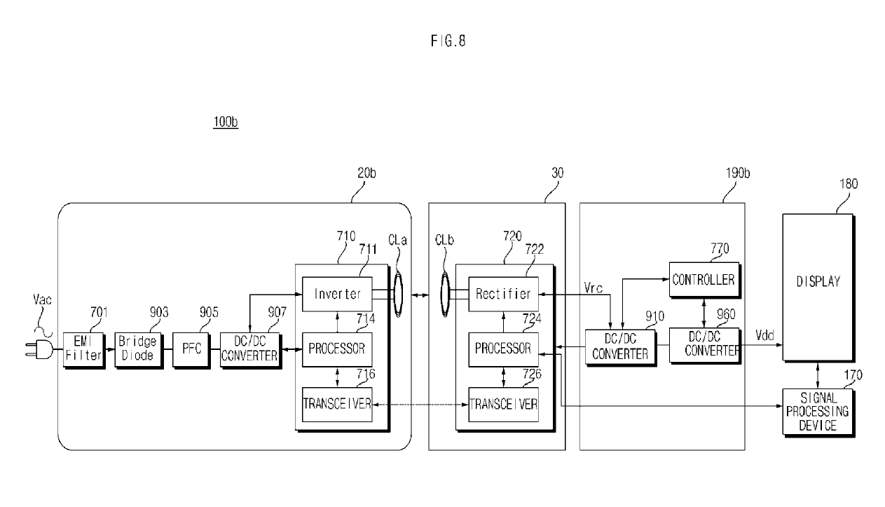

In addition, the power supply 190 supplies corresponding power to the image display apparatus 100. In particular, the power can be supplied to a signal processing device 170 implemented in the form of a system on chip (SOC), a display 180 for displaying an image, and an audio output device 185 for outputting an audio. Specifically, the power supply 190 includes a dc/dc converter (910 in FIG. 7) that converts a first DC voltage Vrc from the wireless power reception device 30 and output a display driving voltage Vdd, and a controller (770 in FIG. 7) that controls the dc/dc converter 910.

Also, the remote controller 200 transmits the user input to the user input interface 150 and can use Bluetooth, a radio frequency (RF) communication, an infrared (IR) communication, an Ultra Wideband (UWB), ZigBee, or the like. In addition, the remote controller 200 can receive the image, audio, or data signal output from the user input interface 150, and display it on the remote controller 200 or output it as an audio. The image display apparatus 100 can be a fixed or mobile digital broadcast receiver capable of receiving digital broadcast.

Also, each component of the block diagram in FIG. 2 can be integrated, added, or omitted according to a specification of the image display apparatus 100 actually implemented. That is, two or more components can be combined into a single component as needed, or a single component can be split into two or more components. The function performed in each block is described for the purpose of illustrating embodiments of the present disclosure, and specific operation and apparatus do not limit the scope of the present disclosure.

Also, the display apparatus 50 illustrated in FIG. 1 can include the wireless power reception device 30, the display 180, the power supply 190, the image receiver 105, the external apparatus interface 130, the memory 140, the user input interface 150, the signal processing device 170, and the audio output device 185.

Next, FIG. 3 is an example of an internal block diagram of the signal processing device in FIG. 2. Referring to the figure, the signal processing device 170 according to an embodiment of the present disclosure can include a demultiplexer 310, an image processor 320, a processor 330, and an audio processor 370. In addition, the signal processing device 170 can further include and a data processor.

In addition, the demultiplexer 310 demultiplexes the input stream. For example, an input MPEG-2 TS can be demultiplexed into image, audio, and data signal, respectively. Here, the stream signal input to the demultiplexer 310 can be a stream signal output from the tuner 110, the demodulator 120, or the external apparatus interface 130.

In addition, the image processor 320 can perform signal processing on an input image. For example, the image processor 320 can perform image processing on an image signal demultiplexed by the demultiplexer 310. As shown in FIG. 3, the image processor 320 can include an image decoder 325, a scaler 335, an image quality processor 635, an image encoder, a graphic processor 340, a frame rate converter 350, a formatter 360, etc.

In addition, the image decoder 325 decodes a demultiplexed image signal, and the scaler 335 performs scaling so that the resolution of the decoded image signal can be output from the display 180. The image decoder 325 can include a decoder of various standards. For example, a 3D image decoder for MPEG-2, H.264 decoder, a color image, and a depth image, and a decoder for a multiple view image can be provided.

Further, the scaler 335 can scale an input image signal decoded by the image decoder 325 or the like. For example, if the size or resolution of an input image signal is small, the scaler 335 can upscale the input image signal, and if the size or resolution of the input image signal is great, the scaler 335 can downscale the input image signal.

Also, the image quality processor 635 can perform image quality processing on an input image signal decoded by the image decoder 325 or the like. For example, the image quality processor 635 can perform noise reduction processing on an input image signal, extend a resolution of high gray level of the input image signal, perform image resolution enhancement, perform high dynamic range (HDR)-based signal processing, change a frame rate, perform image quality processing suitable for properties of a panel, etc.

The graphic processor 340 generates an OSD signal according to a user input or by itself. For example, based on a user input signal, the graphic processor 340 can generate a signal for displaying various information as a graphic or a text on the screen of the display 180. The generated OSD signal can include various data, such as a user interface screen of the image display apparatus 100, various menu screens, a widget, and an icon. In addition, the generated OSD signal can include a 2D object or a 3D object.

In addition, the graphic processor 340 can generate a pointer that can be displayed on the display, based on a pointing signal input from the remote controller 200. In particular, such a pointer can be generated by a pointing signal processing device, and the graphic processor 340 can include such a pointing signal processing device. Also, the pointing signal processing device can be provided separately from the graphic processor 340.

In addition, the frame rate converter (FRC) 350 can convert a frame rate of an input image. The frame rate converter 350 can also output the input image without converting the frame rate. Also, the formatter 360 can change a format of an input image signal into a format suitable for displaying the image signal on a display and output the image signal in the changed format. In particular, the formatter 360 can change a format of an image signal to correspond to a display panel.

Further, the formatter 360 can convert the format of an image signal. Also, the processor 330 can control overall operations of the image display apparatus 100 or the signal processing device 170. For example, the processor 330 can control the tuner 110 to control the tuning of an RF broadcast corresponding to a channel selected by a user or a previously stored channel.

In addition, the processor 330 can control the image display apparatus 100 according to a user command input through the user input interface 150 or an internal program. Further, the processor 330 can transmit data to the network interface 135 or to the external apparatus interface 130and control the demultiplexer 310, the image processor 320, and the like in the signal processing device 170.

Also, the audio processor 370 in the signal processing device 170 can perform the audio processing of the demultiplexed audio signal. Further, the audio processor 370 can include various decoders and process a base, a treble, a volume control, and the like.

In addition, the data processor in the signal processing device 170 can perform data processing of the demultiplexed data signal. For example, the data processor can decode a coded data signal. The encoded data signal can be electronic program guide information including broadcast information, such as a start time and an end time of a broadcast program broadcasted on each channel.

Also, each component of the block diagram in FIG. 3 can be integrated, added, or omitted according to a specification of the signal processing device 170 actually implemented.

In particular, the frame rate converter 350 and the formatter 360 can be provided separately in addition to the image processor 320. The signal processing device 170 according to an embodiment of the present disclosure can further include a neural processor 333 for learning processing, etc.

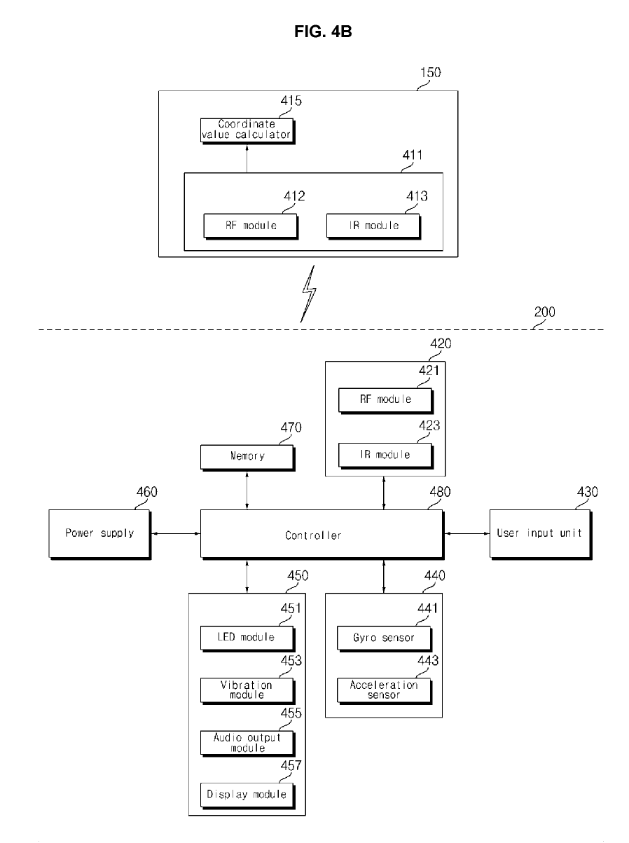

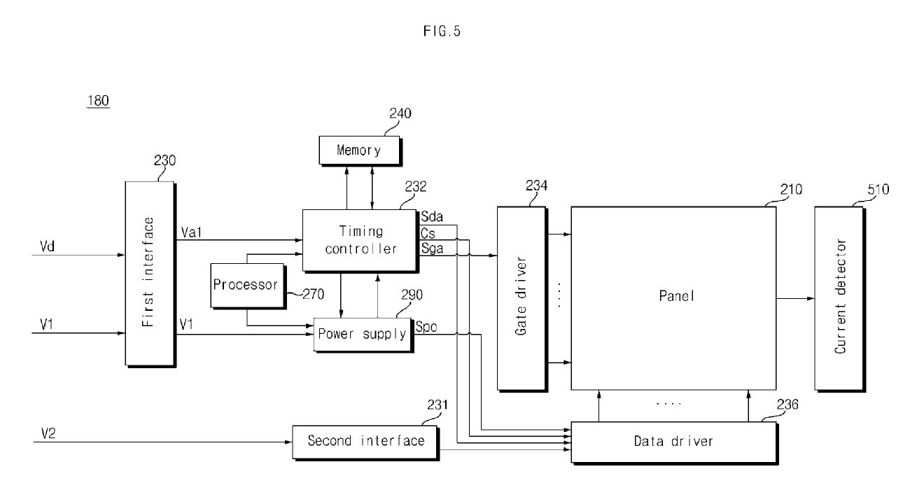

Next, FIG. 4A is a diagram illustrating a control method of a remote controller of FIG. 2. In more detail, FIG. 4A(a) illustrates a pointer 205 corresponding to the remote controller 200 is displayed on the display 180.

Also, the user can move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 can be referred to as a space remote controller or a 3D pointing apparatus, because the pointer 205 is moved and displayed according to the movement in a 3D space, as shown in FIG. 4A.

FIG. 4A(b) illustrates that when the user moves the remote controller 200 to the left, the pointer 205 displayed on the display 180 of the image display apparatus also moves to the left correspondingly. Further, information on the motion of the remote controller 200 detected through a sensor of the remote controller 200 is transmitted to the image display apparatus. The image display apparatus can thus calculate the coordinate of the pointer 205 from the information on the motion of the remote controller 200. The image display apparatus can also display the pointer 205 to correspond to the calculated coordinate.

FIG. 4A(c) illustrates when the user moves the remote controller 200 away from the display 180, while pressing a specific button of the remote controller 200. Thus, a selection area within the display 180 corresponding to the pointer 205 can be zoomed in so that it can be displayed to be enlarged. Also, when the user moves the remote controller 200 close to the display 180, the selection area within the display 180 corresponding to the pointer 205 can be zoomed out so that it can be displayed to be reduced. Also, when the remote controller 200 moves away from the display 180, the selection area can be zoomed out, and when the remote controller 200 approaches the display 180, the selection area can be zoomed in.

In addition, when the specific button of the remote controller 200 is pressed, it is possible to exclude the recognition of vertical and lateral movement. That is, when the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed. Also, the moving speed or the moving direction of the pointer 205 can correspond to the moving speed or the moving direction of the remote controller 200.

Next, FIG. 4B is an internal block diagram of the remote controller of FIG. 2. As shown, the remote controller 200 includes a wireless transceiver 425, a user input device 435, a sensor device 440, an output device 450, a power supply 460, a memory 470, and a controller 480. The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 can include an RF module 421 for transmitting and receiving signals to and from the image display apparatus 100 according to a RF communication standard. In addition, the remote controller 200 can include an IR module 423 for transmitting and receiving signals to and from the image display apparatus 100 according to an IR communication standard.

In the present embodiment, the remote controller 200 transmits a signal containing information on the motion of the remote controller 200 to the image display apparatus 100 through the RF module 421. In addition, the remote controller 200 can receive the signal transmitted by the image display apparatus 100 through the RF module 421. In addition, the remote controller 200 can transmit a command related to power on/off, channel change, volume change, and the like to the image display apparatus 100 through the IR module 423.

Further, the user input device 435 can be implemented by a keypad, a button, a touch pad, a touch screen, or the like. The user can operate the user input device 435 to input a command related to the image display apparatus 100 to the remote controller 200. When the user input device 435 includes a hard key button, the user can input a command related to the image display apparatus 100 to the remote controller 200 through a push operation of the hard key button. When the user input device 435 includes a touch screen, the user can touch a soft key of the touch screen to input the command related to the image display apparatus 100 to the remote controller 200. In addition, the user input device 435 can include various types of input mechanisms, such as a scroll key, a jog key, etc., which can be operated by the user.

Further, the sensor device 440 can include a gyro sensor 441 or an acceleration sensor 443. In particular, the gyro sensor 441 can sense information regarding the motion of the remote controller 200. For example, the gyro sensor 441 can sense information on the operation of the remote controller 200 based on the x, y, and z axes. Also, the acceleration sensor 443 can sense information on the moving speed of the remote controller 200. A distance measuring sensor can be further provided, and thus the distance to the display 180 can be sensed.

Further, the output device 450 can output an image or an audio signal corresponding to the operation of the user input device 435 or a signal transmitted from the image display apparatus 100. Through the output device 450, the user can recognize whether the user input device 435 is operated or whether the image display apparatus 100 is controlled.

For example, the output device 450 can include an LED module 451 that is turned on when the user input device 435 is operated or a signal is transmitted/received to/from the image display apparatus 100 through the wireless transceiver 425, a vibration module 453 for generating a vibration, an audio output module 455 for outputting an audio, or a display module 457 for outputting an image.

In addition, the power supply 460 supplies power to the remote controller 200. When the remote controller 200 is not moved for a certain amount of time, the power supply 460 can stop the supply of power to reduce a power waste. The power supply 460 can then resume power supply when a certain key provided in the remote controller 200 is operated.

Further, the memory 470 can store various types of programs, application data, and the like used for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. In addition, the controller 480 of the remote controller 200 can store information regarding a frequency band or the like for wirelessly transmitting and receiving a signal to/from the image display apparatus 100 paired with the remote controller 200 in the memory 470 and can refer to the stored information.

Further, the controller 480 controls various matters related to the control of the remote controller 200. For example, the controller 480 can transmit a signal corresponding to a certain key operation of the user input device 435 or a signal corresponding to the motion of the remote controller 200 sensed by the sensor device 440 to the image display apparatus 100 through the wireless transceiver 425.

In addition, the user input interface 150 of the image display apparatus 100 includes a wireless transceiver 151 that can wirelessly transmit and receive a signal to and from the remote controller 200 and a coordinate value calculator 415 that can calculate the coordinate value of a pointer corresponding to the operation of the remote controller 200.

The user input interface 150 can also wirelessly transmit and receive a signal to and from the remote controller 200 through the RF module 412. In addition, the user input interface 150 can receive a signal transmitted by the remote controller 200 through the IR module 413 according to an IR communication standard.

Further, the coordinate value calculator 415 can correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 input to the image display apparatus 100 through the user input interface 150 is transmitted to the controller 180 of the image display apparatus 100. Also, the controller 180 can determine the information on the operation of the remote controller 200 and the key operation from the signal transmitted from the remote controller 200, and correspondingly control the image display apparatus 100.

In another example, the remote controller 200 can calculate the pointer coordinate value corresponding to the operation and output the calculated value to the user input interface 150 of the image display apparatus 100. In this instance, the user input interface 150 of the image display apparatus 100 can transmit information on the received pointer coordinate value to the controller 180 without a separate correction process of hand shake or error. In still another example, the coordinate value calculator 415 can be provided in the signal processing device 170, not in the user input interface 150.

Next, FIG. 5 is a block diagram of a display of FIG. 2. Referring to FIG. 5, an organic light-emitting panel-based display 180 can include an organic light-emitting panel 210, a first interface 230, a second interface 231, a timing controller 232, a gate driver 234, a data driver 236, a memory 240, a processor 270, a power supply 290, a current detector 510, and the like.

As shown, the display 180 receives an image signal Vd, a first DC voltage V1, and a second DC voltage V2, and can display a certain image based on the image signal Vd. Also, the first interface 230 in the display 180 can receive the image signal Vd and the first DC voltage V1 from the signal processing device 170. Here, the first DC voltage V1 can be used for the operation of the power supply 290 and the timing controller 232 in the display 180.

Next, the second interface 231 can receive a second DC voltage V2 from an external power supply 190. Also, the second DC voltage V2 can be input to the data driver 236 in the display 180. The timing controller 232 can output a data driving signal Sda and a gate driving signal Sga, based on the image signal Vd. For example, when the first interface 230 converts the input image signal Vd and outputs the converted image signal va1, the timing controller 232 can output the data driving signal Sda and the gate driving signal Sga based on the converted image signal va1.

Further, the timing controller 232 can further receive a control signal, a vertical synchronization signal Vsync, and the like, in addition to the image signal Vd from the signal processing device 170. In addition to the image signal Vd, based on a control signal, a vertical synchronization signal Vsync, and the like, the timing controller 232 generates a gate driving signal Sga for the operation of the gate driver 234, and a data driving signal Sda for the operation of the data driver 236.

Also, when the panel 210 includes a RGBW subpixel, the data driving signal Sda can be a data driving signal for driving of RGBW subpixel. Further, the timing controller 232 can further output a control signal Cs to the gate driver 234.

In addition, the gate driver 234 and the data driver 236 supply a scan signal and an image signal to the organic light-emitting panel 210 through a gate line GL and a data line DL, respectively, according to the gate driving signal Sga and the data driving signal Sda from the timing controller 232. Accordingly, the organic light-emitting panel 210 displays a certain image.

Also, the panel 210 can include an organic light emitting layer. In order to display an image, a plurality of gate lines GL and data lines DL are disposed in a matrix form in each pixel corresponding to the organic light emitting layer. Also, the data driver 236 can output a data signal to the organic light-emitting panel 210 based on a second DC voltage V2 from the second interface 231.

Further, the power supply 290 can supply various power to the gate driver 234, the data driver 236, the timing controller 232, and the like. Also, the current detector 510 can detect the current flowing in a sub-pixel of the panel 210, and the detected current can be input to the processor 270 or the like, for a cumulative current calculation. In addition, the processor 270 can perform each type of control of the display 180. For example, the processor 270 can control the gate driver 234, the data driver 236, the timing controller 232, and the like. Also, the processor 270 can receive current information flowing in a sub-pixel of the panel 210 from the current detector 510.

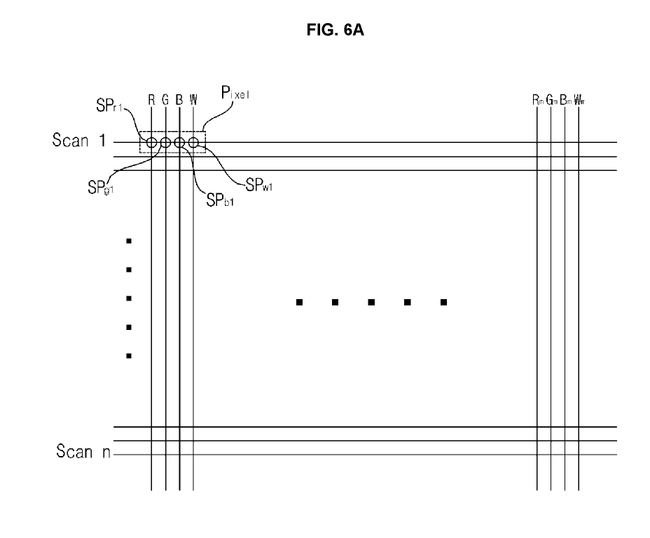

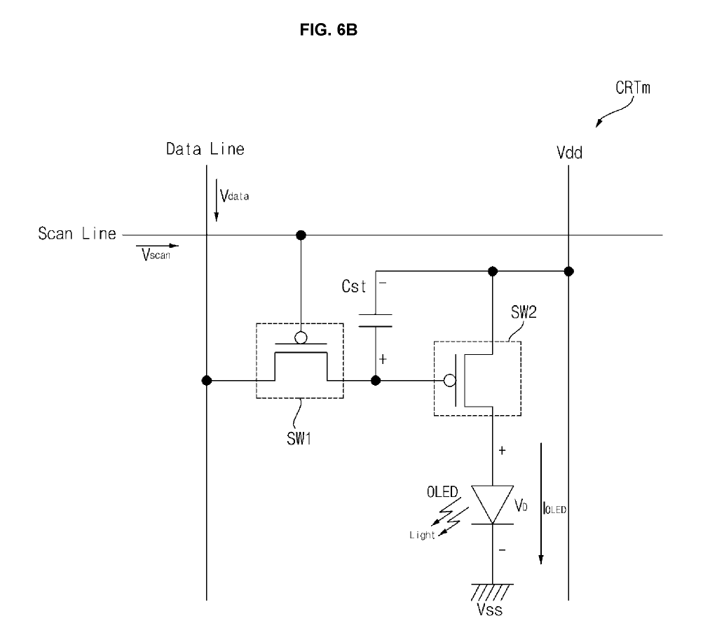

Next, FIGS. 6A and 6B are overviews illustrating an organic light-emitting panel of FIG. 5. In more detail, FIG. 6A is a diagram illustrating a pixel in the organic light-emitting panel 210b.

Referring to FIG. 6A, the organic light-emitting panel 210b can include a plurality of scan lines Scan1 to Scann and a plurality of data lines R1, G1, B1, W1 to Rm, Gm, Bm, Wm intersecting the scan lines. Also, a pixel (subpixel) is defined in an intersecting area of the scan line and the data line in the organic light-emitting panel 210b. FIG. 6A illustrates a pixel including sub-pixels SR1, SG1, SB1, and SW1 of RGBW.

In addition, FIG. 6B illustrates a circuit of any one sub-pixel in the pixel of the organic light-emitting panel of FIG. 6A. Referring to FIG. 6B, an organic light-emitting sub pixel circuit CRTm can include, as an active type, a scan switching element SW1, a storage capacitor Cst, a drive switching element SW2, and an organic light emitting layer OLED.

In more detail, the scan switching element SW1 is turned on according to the input scan signal Vdscan, as a scan line is connected to a gate terminal. When it is turned on, the input data signal Vdata is transferred to the gate terminal of a drive switching element SW2 or one end of the storage capacitor Cst.

Further, the storage capacitor Cst is formed between the gate terminal and the source terminal of the drive switching element SW2, and stores a certain difference between a data signal level transmitted to one end of the storage capacitor Cst and a DC voltage (VDD) level transmitted to the other terminal of the storage capacitor Cst. For example, when the data signal has a different level according to a Plume Amplitude Modulation (PAM) method, the power level stored in the storage capacitor Cst varies according to the level difference of the data signal Vdata.

In another example, when the data signal has a different pulse width according to a pulse width modulation (PWM) method, the power level stored in the storage capacitor Cst changes according to the pulse width difference of the data signal Vdata. Further, the drive switching element SW2 is turned on according to the power level stored in the storage capacitor Cst. When the drive switching element SW2 is turned on, the driving current (IOLED), which is proportional to the stored power level, flows in the organic light emitting layer (OLED). Accordingly, the organic light emitting layer OLED performs a light emitting operation.

In addition, the OLED can include a light emitting layer (EML) of RGBW corresponding to a subpixel, and can include at least one of a hole injecting layer (HIL), a hole transporting layer (HTL), an electron transporting layer (ETL), and an electron injecting layer (EIL). In addition, it can include a hole blocking layer, and the like. Also, the subpixels emit a white light in the organic light emitting layer OLED. However, fo green, red, and blue subpixels, a subpixel is provided with a separate color filter for color implementation. That is, for green, red, and blue subpixels, each of the subpixels further includes green, red, and blue color filters. Also, because a white subpixel outputs a white light, a separate color filter is not required.

Also, FIG. 6B illustrates a p-type MOSFET is used for a scan switching element SW1 and a drive switching element SW2, but an n-type MOSFET or other switching element, such as a JFET, IGBT, SIC, or the like are also available. Also, the pixel is a hold-type element that continuously emits light in the organic light emitting layer (OLED), after a scan signal is applied, during a unit display period, specifically, during a unit frame.

Next, FIG. 7 is a block diagram of an image display apparatus according to an embodiment of the present disclosure. Referring to FIG. 7, the image display apparatus 100 includes the wireless power transmission device 20 that wirelessly transmits power, the wireless power reception device 30 that wirelessly receives power from the wireless power transmission device 20, the power supply 190 that converts the first DC voltage Vrc from the wireless power reception device 30 and outputs the display driving voltage Vdd, and the display 180.

As shown, the image display apparatus 100 further includes the signal processing device 170 that outputs an image signal to the display 180. In addition, the wireless power transmission device 20 includes an ac/dc converter 905 for converting an input AC voltage Vac into a DC voltage, a dc/dc converter 907 for converting the level of the DC voltage from the ac/dc converter 905, a wireless transmitter 710 that operates for wireless power transmission based on the DC voltage from the dc/dc converter 907, and a transmission coil CLa.

Further, as shown, the wireless transmitter 710 can include an inverter 712 that has a plurality of switching elements and is connected to the transmission coil CLa, a processor 714 that controls the inverter 712, and a transceiver 716 that performs communication with the wireless power reception device 30. The transceiver 716 can perform communication based on Bluetooth, ZigBee, ultra-wideband (UWB), Wi-Fi, etc.

In addition, the wireless power reception device 30 includes a reception coil CLb, and a wireless receiver 720 that is connected to the reception coil CLb and operates for wireless power reception. The wireless receiver 720 can also include a rectifier 722 connected to the reception coil CLb, a processor 724 that controls the operation of the rectifier 722, and a transceiver 726 that performs communication with the wireless power transmission device 20.

Further, the rectifier 722 can be configured as a full bridge and can include a plurality of switching elements. Alternatively, the rectifier 722 can be configured as a half bridge and can include a plurality of switching elements and a plurality of diode elements. Alternatively, the rectifier 722 can be configured as a full bridge and can include a plurality of diode elements.

In addition, the transceiver 726 can perform communication based on Bluetooth, ZigBee, ultra-wideband (UWB), Wi-Fi, etc. Also, the power supply 190 includes the dc/dc converter 910 that converts the first DC voltage Vrc from a wireless power reception device 30 and outputs the display driving voltage Vdd, and the controller 770 that controls the dc/dc converter 910.

In addition, the display driving voltage Vdd output from the power supply 190 is supplied to the display 180. If the display 180 is an organic light-emitting panel, the display driving voltage Vdd can be a pixel driving voltage for an organic light-emitting pixel. If the display 180 is an inorganic light-emitting panel, the display driving voltage Vdd can be a pixel driving voltage for an inorganic light-emitting pixel. If the display 180 is a liquid crystal panel, the display driving voltage Vdd can be a backlight driving voltage or a liquid crystal pixel driving voltage.

In addition, the first DC voltage Vrc from the wireless power reception device 30 can change based on the wireless power transmission environment, etc. For example, the input voltage Vac can be approximately 220 V, and the first DC voltage Vrc from the wireless power reception device 30 may be configured to change between approximately VLn and VLm. Specifically, the first DC voltage Vrc may be configured to change between 400 V and 700 V.

Also, the display driving voltage Vdd can be approximately VLp, which is lower than the first DC voltage Vrc. Specifically, the display driving voltage Vdd can be between approximately 21 V and 30 V. That is, the variation range Rga of the first DC voltage Vrc from the wireless power reception device 30 can be greater than the root mean square (RMS) voltage of the input voltage Vac.

Further, the variation range Rga of the first DC voltage Vrc from the wireless power reception device 30 can be less than the peak voltage of the input voltage Vac. The level of the first DC voltage Vrc from the wireless power reception device 30 can be greater than the peak voltage of the input voltage Vac.

As described above, it is perferable for the dc/dc converter 910 in the power supply 190 to stably output the display driving voltage Vdd in response to variation of the first DC voltage Vrc from the wireless power reception device 30. Accordingly, the power supply 190 can further include an input voltage detector DA that detects the first DC voltage Vrc from the wireless power reception device 30.

In addition, the power supply 190 can further include an output voltage detector DD that detects the display driving voltage Vdd output from the dc/dc converter 910 in addition to the input voltage detector DA. Also, power supply 190 can further include an input current detector DB that detects a current flowing from the wireless power reception device 30 to the dc/dc converter 910 in addition to the input voltage detector DA and the output voltage detector DD.

The controller 770 can control the dc/dc converter 910 on the basis of the first DC voltage Vrc detected by the input voltage detector DA. In particular, the controller 770 can control the dc/dc converter 910 based on the first DC voltage Vrc detected by the input voltage detector DA and the display driving voltage Vdd detected by the output voltage detector DD. The controller 770 can also control the dc/dc converter 910 based on the first DC voltage Vrc detected by the input voltage detector DA, the display driving voltage Vdd detected by the output voltage detector DD, and the current detected by the input current detector DB.

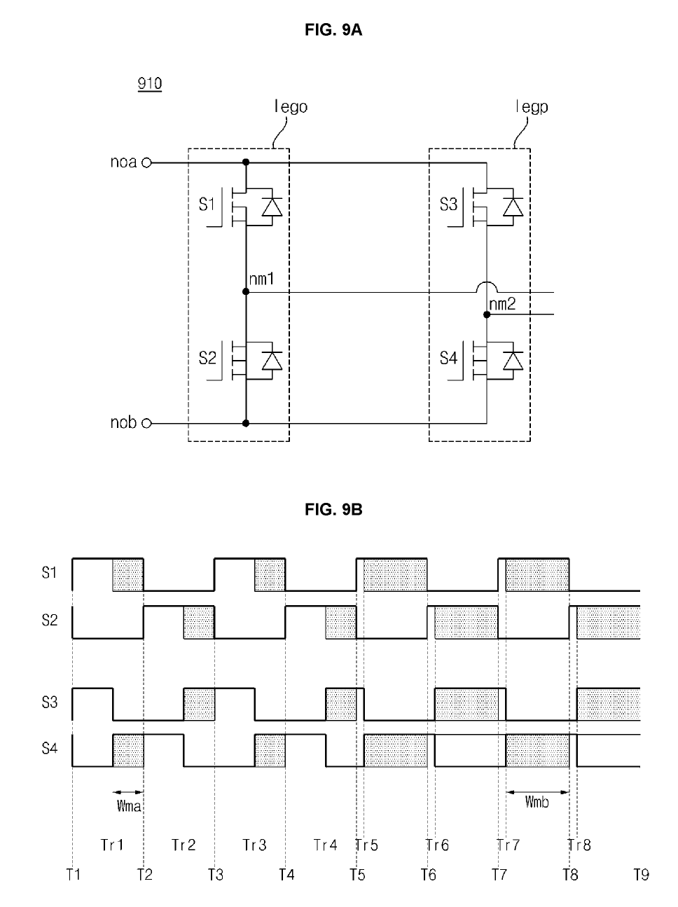

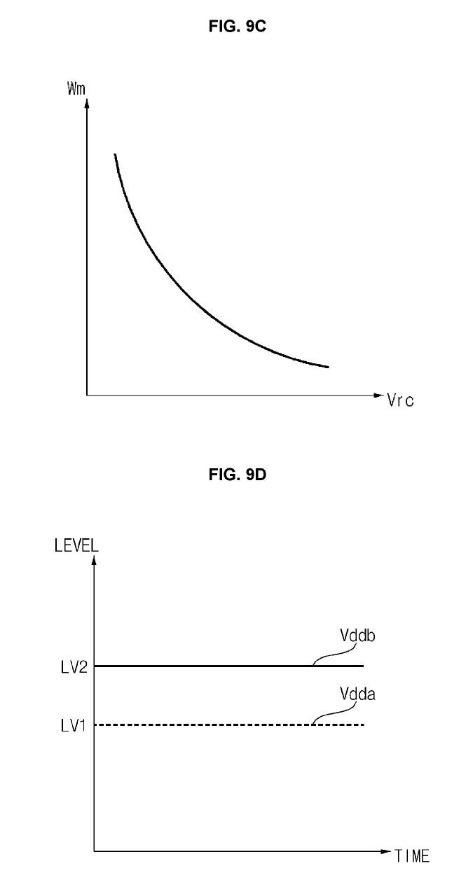

Further, the dc/dc converter 910 includes a plurality of switching elements. Specifically, the dc/dc converter 910 includes a first switching element (S1 in FIG. 9A) and a second switching element (S2 in FIG. 9A) that are connected in series with each other within a first leg (lego in FIG. 9A), and a third switching element (S3 in FIG. 9A) and a fourth switching element (S4 in FIG. 9A) that are connected in series with each other within a second leg (legp in FIG. 9A) that is connected in parallel with the first leg lego.

In addition, the controller 770 can control the first, second, third and fourth switching elements S1, S2, S3, and S4 such that the first switching element S1 and the second and the second switching element S2 switch complementarily and the third switching element S3 and the fourth switching element S4 switch complementarily. The controller 770 is also configured to overlap a portion of turn-on period of the first switching element S1 and the fourth switching element S4 while operating in a phase shift mode and change the overlapping portion in the turn-on period of the first switching element S1 and the fourth switching element S4 based on the level of the first DC voltage Vrc.

In addition, the controller 770 can control the overlapping portion in the turn-on period of the first switching element S1 and the fourth switching element S4 to be a first period when the first DC voltage Vrc is a first level. In particular, the controller 770 can control the overlapping portion in the turn-on period of the first switching element S1 and the fourth switching element S4 to be a second period when the first DC voltage Vrc is a second level that is greater than the first level. For example, the controller 770 can control the overlapping portion in the turn-on period of the first switching element S1 and the fourth switching element S4 to be the first period when the level of the first DC voltage Vrc is approximately 620 V, and control the overlapping portion in the turn-on period of the first switching element S1 and the fourth switching element S4 to be the second period that is less than the first period when the level of the first DC voltage Vrc is approximately 670 V.

In addition, the controller 770 can increase the overlapping portion in the turn-on period of the first switching element S1 and the fourth switching element S4 as the level of the first DC voltage Vrc decreases while operating in the phase shift mode. Accordingly, an image can be stably displayed in response to variation in the first DC voltage Vrc. Further, the controller 770 can operate the phase shift mode when the level of the first DC voltage Vrc is equal to or higher than a reference level, and can perform control such that turn-on period of the first switching element S1 and the fourth switching element S4 completely overlap when the level of the first DC voltage Vrc is lower than the reference level. For example, the controller 770 can operate the phase shift mode when the level of the first DC voltage Vrc is equal to or higher than the reference level and equal to or lower than an upper limit level.

Further, the controller 770 cannot operate phase shift mode when the level of the first DC voltage Vrc is between a lower limit level and the reference level. That is, the controller 770 can completely overlap the turn-on period of the first switching element S1 and the fourth switching element S4. Accordingly, it is possible to display an image stably in response to variation in the level of the first DC voltage Vrc. The controller 770 can also control the wireless power reception device 30 to be powered off when the level of the first DC voltage Vrc is lower than the lower limit level.

Further, the controller 770 can control the wireless power reception device 30 and the wireless power transmission device 20 to be powered off when the level of the first DC voltage Vrc is lower than the lower limit level. In addition, the controller 770 can control the wireless power reception device 30 to be powered off when the level of the first DC voltage Vrc exceeds the upper limit level.

The controller 770 can also control the wireless power reception device 30 and the wireless power transmission device 20 to be powered off when the level of the first DC voltage Vrc exceeds the upper limit level. In particular, the controller 770 can control the wireless power reception device 30 and the wireless power transmission device 20 to be turned on after a predetermined time has elapsed after being powered off. Accordingly, the wireless power reception device 30 and the wireless power transmission device 20 can stably operate.

In addition, the controller 770 can control the overlapping portion in the turn-on period of the first switching element S1 and the fourth switching element S4 to be a third period when the level of the display driving voltage Vdd is a third level. Also, the controller 770 can control the overlapping portion in the turn-on period of the first switching element S1 and the fourth switching element S4 to be a fourth period when the level of the display driving voltage Vdd is a fourth level which is greater than the third level. Accordingly, it is possible to display an image stably in response to variation in the level of the display driving voltage Vdd.

Further, the controller 770 can increase the overlapping portion in the turn-on period of the first switching element S1 and the fourth switching element S4 as the level of the display driving voltage Vdd increases. Accordingly, it is possible to display an image stably in response to variation in the level of the display driving voltage Vdd.

In addition, the controller 770 can control the overlapping portion in the turn-on period of the first switching element S1 and the fourth switching element S4 to be a fifth period when the distance between the wireless power transmission device 20 and the wireless power reception device 30 is a first distance. Further, the controller 770 can control the overlapping portion in the turn-on period of the first switching element S1 and the fourth switching element S4 to be a sixth period greater than the fifth period when the distance between the wireless power transmission device 20 and the wireless power reception device 30 is a second distance greater than the first distance. Accordingly, it is possible to display an image stably in response to variation in the distance between the wireless power transmission device 20 and the wireless power reception device 30.

In addition, the controller 770 can increase the overlapping portion in the turn-on of periods of the first switching element S1 and the fourth switching element S4 as the distance between the wireless power transmission device 20 and the wireless power reception device 30 increases. Accordingly, it is possible to display an image stably in response to variation in the distance between the wireless power transmission device 20 and the wireless power reception device 30.

Next, FIG. 8 is another block diagram of an image display apparatus according to an embodiment of the present disclosure. Referring to FIG. 8, the image display apparatus 100b includes, similarly to the image display apparatus 100 illustrated in FIG. 7, a wireless power transmission device 20b that wirelessly transmits power, a wireless power reception device 30 that wirelessly receives power from the wireless power transmission device 20b, a power supply 190b that converts a first DC voltage Vrc from the wireless power reception device 30 and output a display driving voltage Vdd, and a display 180.

The wireless power transmission device 20b in FIG. 8 includes, as in FIG. 7, an ac/dc converter 905, a dc/dc converter 907, a wireless transmitter 710, and a transmission coil CLa. The wireless power transmission device 20b in FIG. 8 can further include an electromagnetic interference (EMI) noise blocking filter 701 and a rectifier 903 including a diode element in front of the ac/dc converter 905. The wireless power reception device 30 in FIG. 8 includes a reception coil CLb and a wireless receiver 720.

In addition, the power supply 190b in FIG. 8 can include a dc/dc converter 910 that converts the first DC voltage Vrc to output a second DC voltage, a second dc/dc converter 960 that converts the level of the second DC voltage of the dc/dc converter 910 to output the display driving voltage Vdd, and a controller 770 that controls the dc/dc converter 910 and the second dc/dc converter 960. For example, the dc/dc converter 910 in FIG. 8 can convert the first DC voltage Vrc of approximately 400 V to 700 V and output the second DC voltage of approximately 45 V to 50 V.

Further, the second dc/dc converter 960 can convert the second dc voltage of approximately 45 V to 50 V and output the display driving voltage Vdd of approximately 21 V to 30 V. Accordingly, the display driving voltage Vdd can be output stably.

Next, FIG. 9A to FIG. 14C are diagrams referenced in descriptions of FIG. 7 and FIG. 8. In particular, FIG. 9A is a diagram illustrating a plurality of switching elements within the dc/dc converter 910 in FIGS. 7 and 8.

Referring to FIG. 9A, the dc/dc converter 910 includes a first switching element S1 and a second switching element S2 that are connected in series with each other within a first leg lego between a noa node and a nob node, and a third switching element S3 and a fourth switching element S4 that are connected in series with each other within a second leg legp that is connected in parallel with the first leg lego.

A node nm1 between the first switching element S1 and the second switching element S2 and a node nm2 between the third switching element S3 and the fourth switching element S4 can be electrically connected to the input side of the transformer 905 in FIG. 11. The controller 770 can output a switching control signal for switching each of the switching elements S1 to S4. For example, the controller 770 can control the first switching element S1 and the second switching element S2 to switch complementarily and control the third switching element S3 and the fourth switching element S4 to switch complementarily.

In addition, the controller 770 can operate a phase shift mode when the level of the first DC voltage Vrc is equal to or higher than a reference level. The controller 770 can also control turn-on period of the first switching element S1 and the fourth switching element S4 to completely overlap when the level of the first DC voltage Vrc is lower than the reference level.

Next, FIG. 9B is a diagram referenced in description of the phase shift mode. Referring to FIG. 9B, the controller 770 can output a high-level switching control signal during periods T1 to T2, T3 to T4, T5 to T6, and T7 to T8 to turn on the first switching element S1.

The controller 770 can also output a low-level switching control signal during periods T2 to T3, T4 to T5, T6 to T7, and T8 to T9 to turn off the first switching element S1. Further, the controller 770 can control the second switching element S2 to operate complementarily with respect to the first switching element S1. That is, the controller 770 can output the low-level switching control signal during the periods T1 to T2, T3 to T4, T5 to T6, and T7 to T8 to turn off the second switching element S2.

In addition, the controller 770 can output the high-level switching control signal during the periods sections T2 to T3, T4 to T5, T6 to T7, and T8 to T9 to turn on the second switching element S2. The controller 770 can also overlap a portion the turn-on period of the first switching element S1 and the fourth switching element S4 in the phase shift mode.

As shown in FIG. 9B, the controller 770 can output the high-level switching control signal during periods Tr1 to Tr2, Tr3 to Tr4, Tr5 to Tr6, and Tr7 to Tr8 to turn on the fourth switching element S3. The controller 770 can also output the low-level switching control signal during periods T1 to Tr1, Tr2 to Tr3, Tr4 to Tr5, and Tr6 to Tr7 to turn off the fourth switching element S4.

Further, the controller 770 can control the third switching element S3 to operate complementarily with respect to the fourth switching element S4. That is, the controller 770 can output the low-level switching control signal during the periods Tr1 to Tr2, Tr3 to Tr4, Tr5 to Tr6, and Tr7 to Tr8 to turn off the third switching element S3.

In addition, the controller 770 can output the high-level switching control signal during the periods T1 to Tr1, Tr2 to Tr3, Tr4 to Tr5, and Tr6 to Tr7 to turn on the third switching element S3. That is, the controller 770 can overlap a portion the turn-on period of the second switching element S2 and the third switching element S3 in the phase shift mode.

As shown, the turn-on period of the first switching element S1 and the fourth switching element S4 overlap during the periods Tr1 to T2, Tr3 to T4, Tr5 to T6, and Tr7 to T8 in the phase shift mode. The controller 770 can also change the overlapping portion during turn-on period of the first switching element S1 and the fourth switching element S4 based on the level of the first DC voltage Vrc.

For example, the controller 770 can control the overlapping portion in the turn-on period of the first switching element S1 and the fourth switching element S4 to be a first period Wmb corresponding to the period Tr7 to T8 when the level of the first DC voltage Vrc is approximately 620 V, and control the overlapping portion in the turn-on period of the first switching element S1 and the fourth switching element S4 to be a second period Wma corresponding to the period Tr1 to T2 when the level of the first DC voltage Vrc is approximately 670 V.

As shown in FIG. 9B, it is preferable that the second period Wma be shorter than the first period Wmb. Accordingly, it is possible to display an image stably in response to variation in the first DC voltage Vrc. The controller 770 can also operate the phase shift mode when the level of the first DC voltage Vrc is equal to or higher than the reference level and equal to or lower than the upper limit level.

In addition, the controller 770 cannot operate the phase shift mode when the level of the first DC voltage Vrc is between the lower limit level and the reference level. Accordingly, it is possible to display an image stably in response to variation in the level of the first DC voltage Vrc. Further, the controller 770 can control the wireless power reception 30 and the wireless power transmission device 20 to be powered off when the level of the first DC voltage Vrc is lower than the lower limit level or higher than the upper limit level.

Also, the controller 770 can control the wireless power reception device 30 and the wireless power transmission device 20 to be turned on after a predetermined time has elapsed after being powered off. Accordingly, the wireless power reception device 30 and the wireless power transmission device 20 can stably operate.

Next, FIG. 9C is a diagram illustrating the overlapping portion in the turn-on period of the first switching element S1 and the fourth switching element S4 based on the level of the first DC voltage Vrc. Referring to FIG. 9C, as the level of the first DC voltage Vrc increases, the overlapping portion in the turn-on period of the first switching element S1 and the fourth switching element S4 decreases.

Accordingly, the controller 770 can reduce the overlapping portion in the turn-on period of the first switching element S1 and the fourth switching element S4 as the level of the first DC voltage Vrc increases while operating in the phase shift mode. The controller 770 can also increase the overlapping portion in the turn-on period of the first switching element S1 and the fourth switching element S4 as the level of the first DC voltage Vrc decreases while operating in the phase shift mode.

Next, FIG. 9D illustrates various examples of a display driving voltage level. Referring to FIG. 9D, the dc/dc converter 910 can output a plurality of display driving voltages Vdda and Vddb. For example, the first display driving voltage Vdda can be a third level LV1, and the second display driving voltage Vddb can be a fourth level LV2.

Here, the third level LV1 can be approximately 22 V, and the fourth level LV2 can be approximately 24 V. The controller 770 can also control the overlapping portion in the turn-on period of the first switching element S1 and the fourth switching element S4 to be the third period Wma when the level of the display driving voltage Vdd is the third level LV1.

In addition, the controller 770 can control the overlapping portion in the turn-on period of the first switching element S1 and the fourth switching element S4 to be the fourth period Wmb greater than the third period Wma when the level of the display driving voltage Vdd is the fourth level LV2 higher than the third level LV1. Accordingly, it is possible to stably display an image in response to variation in the level of the display driving voltage Vdd.

Further, the dc/dc converter 910 can output a third display driving voltage at a fifth level LV3. Here, the fifth level LV3 can be approximately 28 V. The controller 770 can also control the overlapping portion in the turn-on period of the first switching element S1 and the fourth switching element S4 to be greater than the fourth period Wmb when the level of the display driving voltage Vdd is the fifth level greater than the fourth level LV2. Accordingly, it is possible to stably display an image in response to variation in the level of the display driving voltage Vdd.

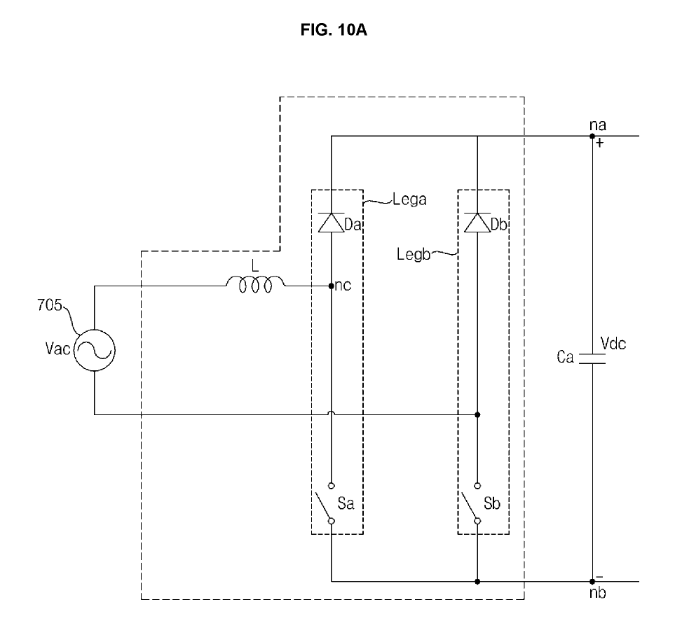

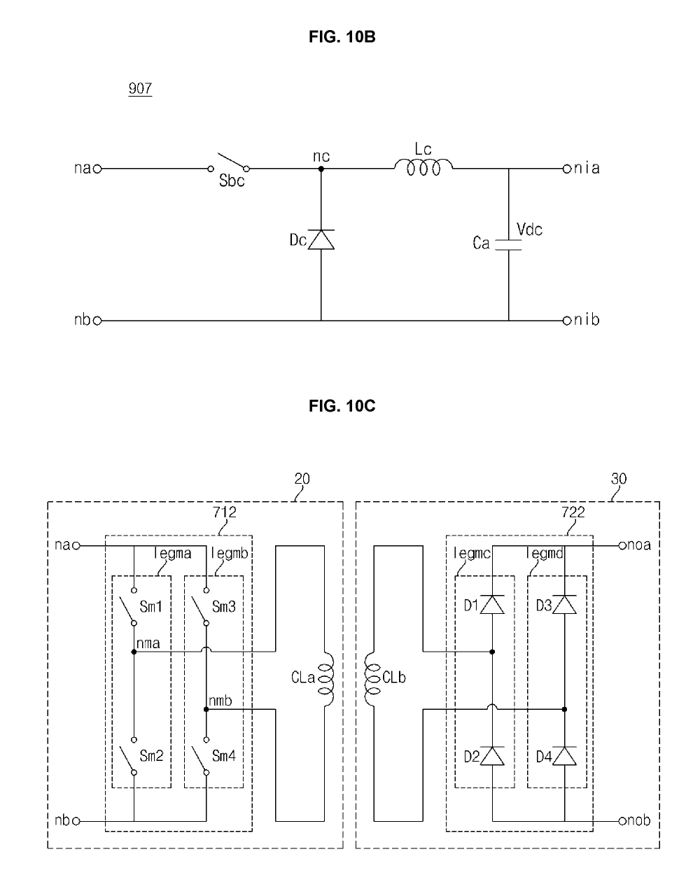

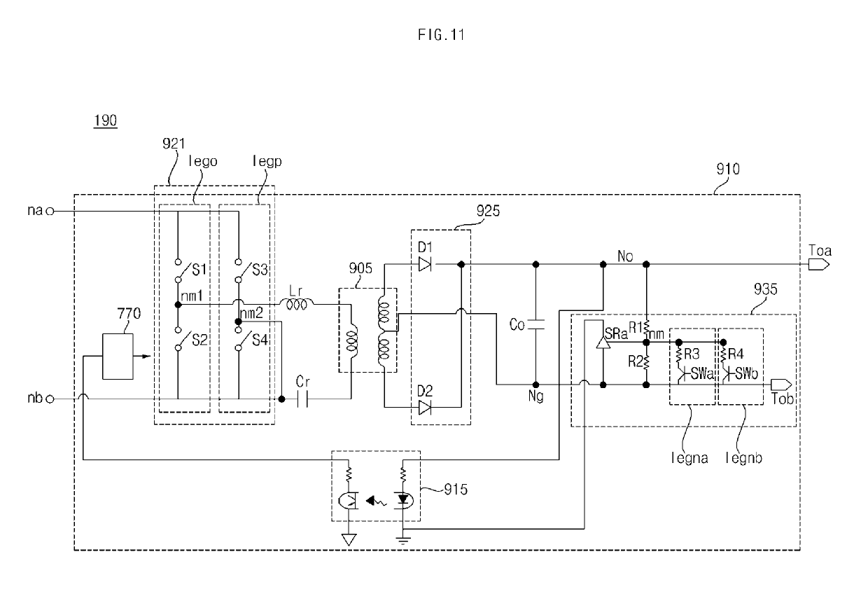

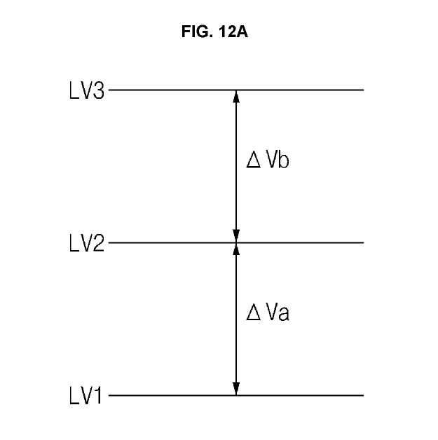

Next, FIG. 10A illustrates an example of the ac/dc converter 905 in FIGS. 7 and 8. Referring to FIG. 10A, the ac/dc converter 905 includes a plurality of switching elements Sa and Sb and a plurality of diode elements Da and Db, and can convert the level of an input AC voltage Vac to output a DC voltage Vdc according to switching operations of the switching elements Sa and Sb.

Specifically, the ac/dc converter 905 can include a third leg legb having the first diode element Da and the first switching element Sa that are connected in series with each other, and a fourth leg legb that is connected in parallel with the third leg legb and has the second diode element Db and the second switching element Sb that are connected in series with each other. One end (cathode) of the first diode element Da can be connected to one end na of the output terminal na-nb of the ac/dc converter 905, and the other end (anode) of the first diode element Da can be connected to a first node nc.

As shown, one end of the first switching element Sa can be connected to the first node nc, and the other end of the first switching element Sa can be connected to the other end nb of the output terminal na-nb of the ac/dc converter 905. One end (cathode) of the second diode element Db can be connected to one end na of the output terminal na-nb of the ac/dc converter 905, and the other end (anode) of the second diode element Db can be connected to the second node nd.

Also, one end of the second switching element Sb can be connected to the second node nd, and the other end of the second switching element Sb can be connected to the other end nb of the output terminal na-nb of the ac/dc converter 905. The ac/dc converter 905 in FIG. 10A can be called a half-bridge type ac/dc converter.

In addition, the ac/dc converter 905 can further include an inductor L disposed between the first node na between the first diode element Da and the first switching element Sa and the input terminal to which the input AC voltage Vac is input. Further, the dc/dc converter 907 connected to both ends of a dc capacitor Ca can be connected to the output terminal nc-nd of the ac/dc converter 905.

Next, FIG. 10B illustrates an example of the dc/dc converter 907 in FIGS. 7 and 8. Referring to FIG. 10B, the dc/dc converter 907 can convert the level of the DC voltage from the ac/dc converter 905. For example, the dc/dc converter 907 can be a buck converter that converts the level of the DC voltage from the ac/dc converter 905.

That is, the dc/dc converter 907 can include a switching element Sbc having one end connected to a node na, a diode element Dc connected between the other end of the switching element Sbc and a node nb, an inductor Lc having one end connected to the anode of the diode element Dc, and a capacitor Cc connected to the other end of the inductor Lc. In addition, the switching element Sbc can be connected between the node na and a node nc, the inductor Lc can be connected between the node nc and a node nia, the capacitor Cc can be connected between the node nia and a node nib, and the diode element Dc can be connected between the node nc and the node nb.

When the switching element Sbc is turned on, current flows through the switching element Sbc and the inductor Lc, and when the switching element Sbc is turned off, current flows through the diode element Dc and the switching element Sbc. Accordingly, a level-converted DC voltage is output.

Next, FIG. 10C illustrates an example of the wireless power transmission device 20 and the wireless power reception device 30 in FIGS. 7 and 8. Referring to FIG. 10C, the wireless power transmission device 20 includes a transmission coil CLa and an inverter 712 that is connected to the transmission coil CLa and has a plurality of switching elements Sm1 to Sm4.

The inverter 712 includes a fifth switching element Sm1 and a sixth switching element Sm2 that are connected in series with each other within a fifth leg legma, and a seventh switching element Sm3 and an eighth switching element Sm4 that are connected in series with each other within a sixth leg legmb that is connected in parallel with the fifth leg legma. Also, the wireless power reception device 30 includes a reception coil CLb and a rectifier 722 connected to the reception coil CLb.

In addition, the rectifier 722 can include a third diode element D1 and a fourth diode element D2 connected in series with each other within a seventh leg legmc, and a fifth diode element D3 and a sixth diode element D4 connected in series with each other within an eighth leg legmd connected in parallel with the seventh leg legmc.

Next, FIG. 11 is an exemplary circuit diagram of the dc/dc converter within the power supply according to an embodiment of the present disclosure. Referring to FIG. 11, the dc/dc converter 910 in the power supply 190 includes a full bridge switch 921, a transformer 905 connected to an output terminal of the full bridge switch 921, and a rectifier 925 connected to an output terminal of the transformer 905.

As shown, the full bridge switch 921 includes a first switching element S1 and a second switching element S2 connected in series with each other within a first leg lego, and a third switching element S3 and a fourth switching element S4 connected in series with each other within a second leg legp connected in parallel with the first leg legp.

In addition, the dc/dc converter 910 in the power supply 190 can further include a resonant capacitor Cr and a resonant inductor Lr connected between the dc/dc converter 910 and the transformer 905. Accordingly, the dc/dc converter 910 is an LLC-based resonant dc/dc converter, and can supply a display driving voltage by utilizing resonance. In particular, the display driving voltage can be output through a terminal Toa in the figure. The terminal Tob can be a ground terminal.

Further, the dc/dc converter 910 in the power supply 190 can further include a multi-level voltage output circuit 935 connected to the output terminal of the rectifier 925 and configured to output a plurality of display driving voltages based on a plurality of display modes. The dc/dc converter 910 can further include a capacitor Co disposed between the output terminal No-Ng of the transformer 905 and the multi-level voltage output circuit 935.

In addition, the multi-level voltage output circuit 935 according to the embodiment of the present disclosure includes a first resistor element R1 and a second resistor element R2 disposed at the output terminal No-Ng of the transformer 905 and connected in series to each other, a third resistor element R3 and a ninth switching element SWa disposed at a ninth leg legna connected in parallel to both ends of the second resistor element R2, and connected in series to each other, and a fourth resistor element R4 and a tenth switching element SWb disposed at a tenth leg legnb connected in parallel to both ends of the second resistor element R2, and connected in series to each other.

That is, the third resistor element R3 and the ninth switching element SWa are connected in series to each other in the first leg between a terminal nm and a terminal Ng that are both ends of the second resistor element R2. Further, the fourth resistor element R4 and the tenth switching element SWb are connected in series to each other in the second leg between the terminal nm and the terminal Ng that are both ends of the second resistor element R2.

The power supply 190 can output a display driving voltage at the third level LV1, a display driving voltage at the fourth level LV2, or a display driving voltage at the fifth level LV3 according to on or off of the ninth switching element SWa or the tenth switching element SWb. For example, in the first mode, if both the ninth switching element SWa and the tenth switching element SWb are turned off, the power supply 190 can output a display driving voltage of a third level LV1.

As another example, in the second mode, if one of the ninth switching element SWa and the tenth switching element SWb is turned on, and the other one is turned off, the power supply 190 can output a display driving voltage of a fourth level LV2. As yet another example, in the third mode, if both the ninth switching element SWa and the tenth switching element SWb are turned on, the power supply 190 can output a display driving voltage of a fifth level LV3. Accordingly, it is possible to reduce heat generation by supplying various display driving voltages.

The dc/dc converter 910 can further include a voltage detector 915 that detects a display driving voltage output from the output terminal No-Ng of the transformer 905, and a controller 770 that controls the first to fourth switching elements S1 to S4 based on a voltage detected by the voltage detector 915. The voltage detector 915 can include a regulator SRa that is electrically connected to one end of the second resistor element R2, and a photo coupler PTD that is electrically connected to the regulator SRa and transmits the voltage across both ends of the second resistor element R2 to the controller 770. Accordingly, various display driving voltages can be supplied to reduce heat generation based on feedback of the voltage across both ends of the second resistor element R2.

Also, the voltage detector 915 can detect the voltage at both ends nm-Ng of the second resistor element R2, and the controller 770 can increase the voltage at the output terminal No-Ng of the transformer 905 as the voltage at both ends of the second resistor element R2 becomes lower.

In addition, the voltage detector 915 can detect the voltage at both ends nm-Ng of the second resistor element R2, and the switching controller can decrease the voltage at the output terminal No-Ng of the transformer 905 as the voltage at both ends of the second resistor element R2 becomes higher. For example, while operating in a first mode, if the voltage detected by the voltage detector 915 is lower than a first reference voltage corresponding to the first mode, the controller 770 can control the first to fourth switching elements S1 to S4 for the voltage detected by the voltage detector 915 to reach the first reference voltage.

Specifically, while operating in a first mode, if the voltage detected by the voltage detector 915 is lower than a first reference voltage corresponding to the first mode, the controller 770 can increase the turn-on duty of the first to fourth switching elements S1 to S4. Accordingly, a display driving voltage corresponding to the first mode can be supplied.

As another example, while operating in a first mode, if the voltage detected by the voltage detector 915 is higher than a first reference voltage corresponding to the first mode, the controller 770 can control the first to fourth switching elements S1 to S4 for the voltage detected by the voltage detector 915 to reach the first reference voltage. Specifically, while operating in a first mode, if the voltage detected by the voltage detector 915 is higher than a first reference voltage corresponding to the first mode, the controller 770 can decrease the turn-on duty of the first to fourth switching elements S1 to S4. Accordingly, a display driving voltage corresponding to the first mode can be supplied.

In addition, if the voltage detected by the voltage detector 915 is lower than a second reference voltage corresponding to the second mode, the controller 770 can control the first to fourth switching elements S1 to S4 for the voltage detected by the voltage detector 915 to reach the second reference voltage. Accordingly, a display driving voltage corresponding to the second mode can be supplied.

The controller 770 can also control the first to fourth switching elements S1 to S4 such that the voltage detected by the voltage detector 915 reaches the third reference voltage when the voltage detected by the voltage detector 915 is lower than the third reference voltage corresponding to the third mode. Accordingly, the display driving voltage corresponding to the third mode can be supplied.

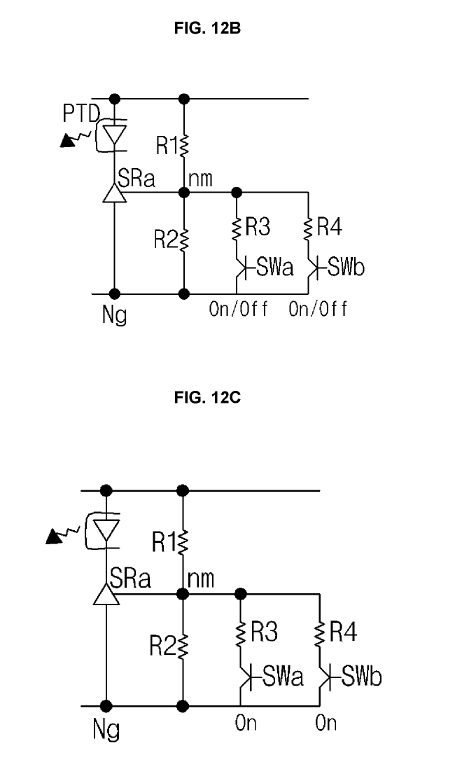

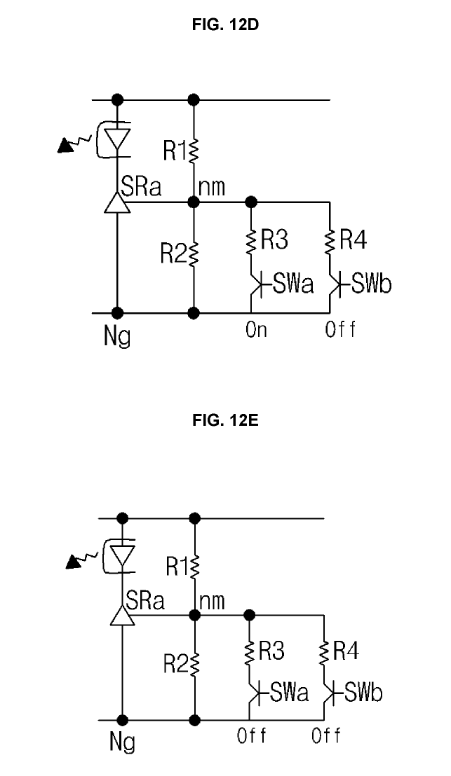

Next, FIGS. 12A to 12E are diagrams referenced in description of FIG. 11. In particular, FIG. 12A is a diagram illustrating various display driving voltage levels.

Referring to FIG. 12A, the power supply 190 can output one of the display driving voltage of the third level LV1, the display driving voltage of the fourth level LV2, or the display driving voltage of the fifth level LV3. Also, it is preferable that the difference Vb between the fifth level LV3 and the fourth level LV2 be greater than the difference Va between the fourth level LV2 and the third level LV1. For example, the display driving voltage of the third level LV1 can be approximately 22 V, the display driving voltage of the fourth level LV2 can be approximately 24 V, and the display driving voltage of the fifth level LV3 can be approximately 28 V.

Next, FIG. 12B is a diagram illustrating the multi-level voltage output circuit 935 of FIG. 11. Referring to FIG. 12B, the multi-level voltage output circuit 935 includes a first resistor element R1 and a second resistor element R2 connected in series with each other at the output terminal No-Ng of the transformer 905 and, a third resistor element R3 and a ninth switching element SWa connected in series with each other in a ninth leg legna connected in parallel with both ends of the second resistor element R2, and a fourth resistor element R4 and a tenth switching element SWb connected in series with each other in a tenth leg legnb connected in parallel with both ends of the second resistor element R2.

Also, the voltage detector 915 can include a regulator SRa electrically connected to one end of the second resistor element R2 and a photo coupler PTD electrically connected to the regulator SRa, for transmitting the voltage between both ends of the second resistor element R2 to the controller 770. As shown in FIG. 12B, the photo coupler PTD can be disposed between one end No of the first resistor element and the regulator SRa. The voltage detector 915 can transmit a detected current or a detected voltage to the controller 770, based on the conduction of the photo coupler PTD.

Next, FIGS. 12C to 12E are diagrams illustrating an operation of the multi-level voltage output circuit 935 in the first to third modes. In particular FIG. 12C illustrates the third mode in which both of the ninth switching element SWa and the second switching element Swb are turned on.

In addition, FIG. 12D illustrates the second mode in which one of the ninth switching element SWa and the second switching element Swb is turned on, and FIG. 12E illustrates the first mode in which both the ninth switching element SWa and the second switching element Swb are turned off. For example, a description will now be given assuming the first to fourth resistor elements have a resistance value of 2 kΩ.

In the first mode, both the ninth switching element SWa and the tenth switching element SWb are turned off, and therefore the total resistance is approximately 4 kΩ because of the first resistor element and the second resistor element. In the second mode, one of the ninth switching element SWa and the tenth switching element SWb is turned on, and therefore the resistance at both ends of the second resistor element is 1 kΩ, and the total resistance is approximately 3 kΩ in consideration of the first resistor element.

In the third mode, both the ninth switching element SWa and the tenth switching element SWb are turned on, and therefore the resistance at both ends of the second resistor element is 0.67 kΩ, and the total resistance is approximately 2.67 kΩ in consideration of the first resistor element. Consequently, the total resistance is highest in the first mode, and the total resistance is lowest in the third mode.

In addition, the power supply 190 outputs one of the display driving voltages of the third level LV1, the display driving voltage of the fourth level LV2, or the display driving voltage of the fifth level LV3 by using the difference in the total resistance value within the multi-level voltage output circuit 935 in the first mode to the third mode. Accordingly, by supplying various display driving voltages in various modes, images can be stably displayed in various modes.

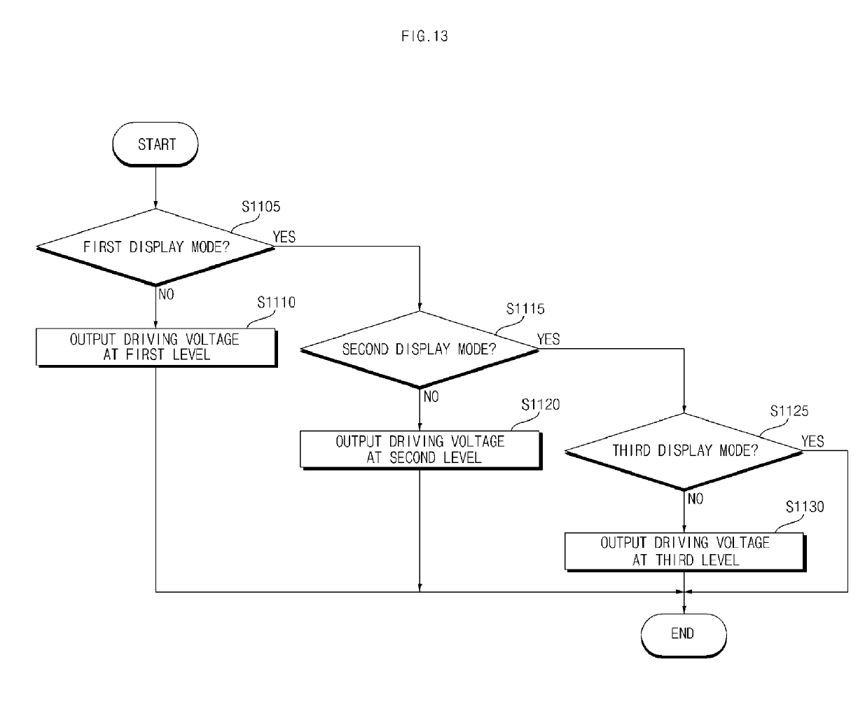

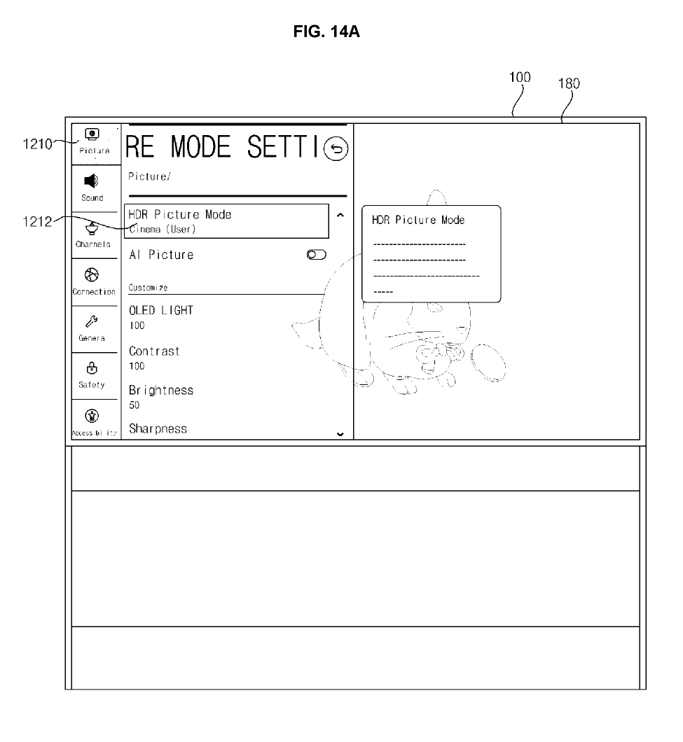

Next, FIG. 13 is a flow chart showing a method of operating an image display apparatus according to an embodiment of the present disclosure. Referring to FIG. 13, the signal processing device 170 of the image display apparatus 100 can output a display driving voltage for a selected mode among the first to third modes displayed in a settings screen.

In particular, the signal processing device 170 of the image display apparatus 100 determines whether the first mode is set (S1105), and, if so, the power supply 190 is configured to output a display driving voltage of a third level LV1 (S1110). If the first mode is not set, the signal processing device 170 of the image display apparatus 100 determines whether the second mode is set (S1115), and, if so, the power supply 190 is configured to output a display driving voltage of a fourth level LV2 (S1120).

In addition, if the second mode is not set, the signal processing device 170 of the image display apparatus 100 determines whether the third mode is set (S1125), and, if so, the power supply 190 is configured to output a display driving voltage of a fifth level LV3 (S1130). Also, the first mode can be a first display mode or a first brightness mode. Accordingly, it is possible to reduce heat generation by supplying various display driving voltages.

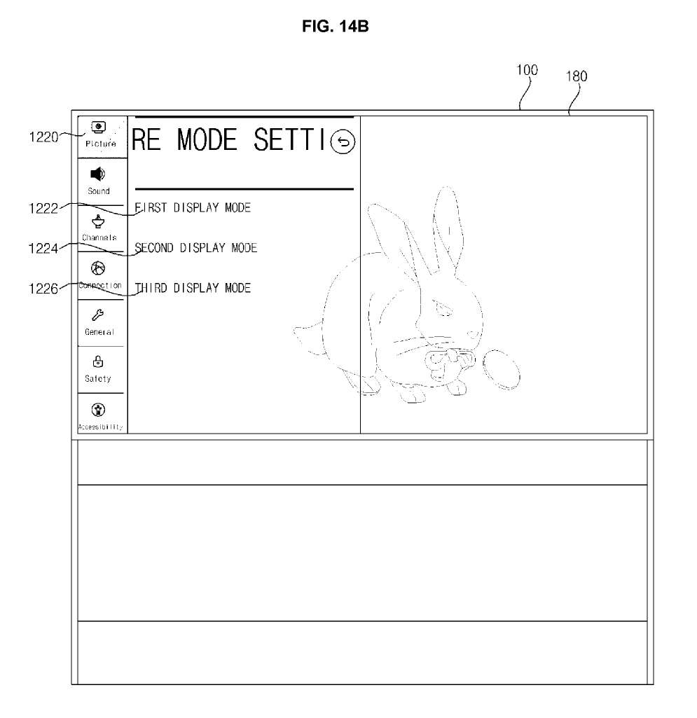

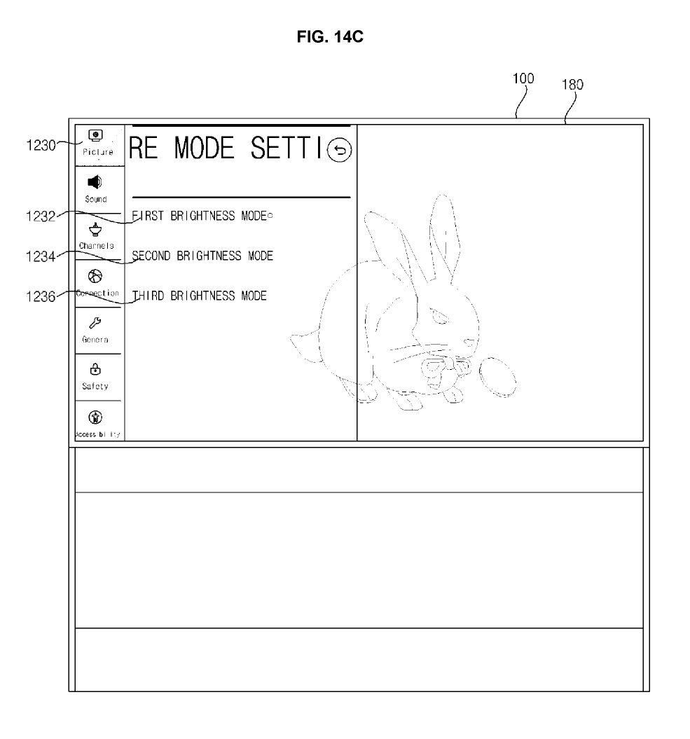

Next, FIGS. 14A to 14C are diagrams referred to in the description of FIG. 13. In particular, FIG. 14A illustrate that a high dynamic range mode item 1212 is selected as an image output mode in a settings screen 1210 shown on the display 1800.

If the high dynamic range mode item 1212 is selected based on the remote control signal, the signal processing device 170 performs the High Dynamic Range mode as the image output mode. Further, the signal processing device 170 can send a third mode selection signal to the power supply 190.

Also, if the image output mode of the signal processing device 170 is the High Dynamic Range mode, the power supply 190 can receive a third mode selection signal from the signal processing device 170 and output a display driving voltage of a fifth level LV3 based on the third mode selection signal. Accordingly, it is possible to supply a display driving voltage corresponding to High Dynamic Range mode, and, as a result, to reduce heat generation.

Next, FIG. 14B illustrates that a first display mode item 1222, a second display mode item 1224, and a third display mode item 1226 are displayed in the settings screen 1220 shown on the display 1800. The first display mode can correspond to display power control (DPC)-on mode.

Also, the second display mode can correspond to display power control (DPC)-off mode, and the third display mode can correspond to peak-on mode. If the first display mode item 1222 corresponding to display power control-on mode is selected in the settings screen 1220, the signal processing device 170 can control the power supply 190 to supply the display driving voltage of the third level LV1 to the display 180 based on the first mode.

In addition, if the first display mode item 1224 corresponding to display power control-off mode is selected in the settings screen 1220, the signal processing device 170 can control the power supply 190 to supply the display driving voltage of the fourth level LV2 to the display 180 based on the second mode.

Also, if the third display mode item 1226 corresponding to peak-on mode is selected in the settings screen 1220, the signal processing device 170 can control the power supply 190 to supply the display driving voltage of the fifth level LV3 to the display 180 based on the third mode.

Next, FIG. 14C illustrates that a first brightness mode item 1232, a second brightness mode item 1234, and a third brightness mode item 1236 are displayed in the settings screen 1230 shown on the display 1800. The first brightness mode can correspond to Eco mode or Standard mode which is an image output mode.

In addition, the second brightness mode can correspond to Cinema mode or Game mode which is an image output mode, and the third brightness mode can correspond to High Dynamic Range mode which is an image output mode.

If the first brightness mode item 1232 corresponding to Eco mode or Standard mode is selected in the settings screen 1230, the signal processing device 170 can control the power supply 190 to supply the display driving voltage of the third level LV1 to the display 180 based on the first mode. In addition, if the first brightness mode item 1234 corresponding to Cinema mode or Game mode is selected in the settings screen 1230, the signal processing device 170 can control the power supply 190 to supply a display driving voltage of a fourth level LV2 to the display 180 based on a second mode.

If the third brightness mode item 1236 corresponding to High Dynamic Range mode is selected in the settings screen 1230, the signal processing device 170 can control the power supply 190 to supply a display driving voltage of a fifth level LV3 to the display 180 based on a third mode.

Also, the power supply 190 according to an embodiment of the present disclosure varies the level of the display driving voltage based on the image output mode of the signal processing device 170. For example, the controller 770 in the power supply 190 can output a first display driving voltage when the image output mode of the signal processing device 170 is an eco mode or a standard mode, and to output a second display driving voltage that is higher than the first display driving voltage when the image output mode of the signal processing device 170 is a movie mode or a game mode.

As another example, the controller 770 in the power supply 190 can output a third display driving voltage that is higher than the second display driving voltage when the image output mode of the signal processing device 170 is a high dynamic range mode. Accordingly, various display driving voltages can be stably output in various modes, thereby stably displaying an image.

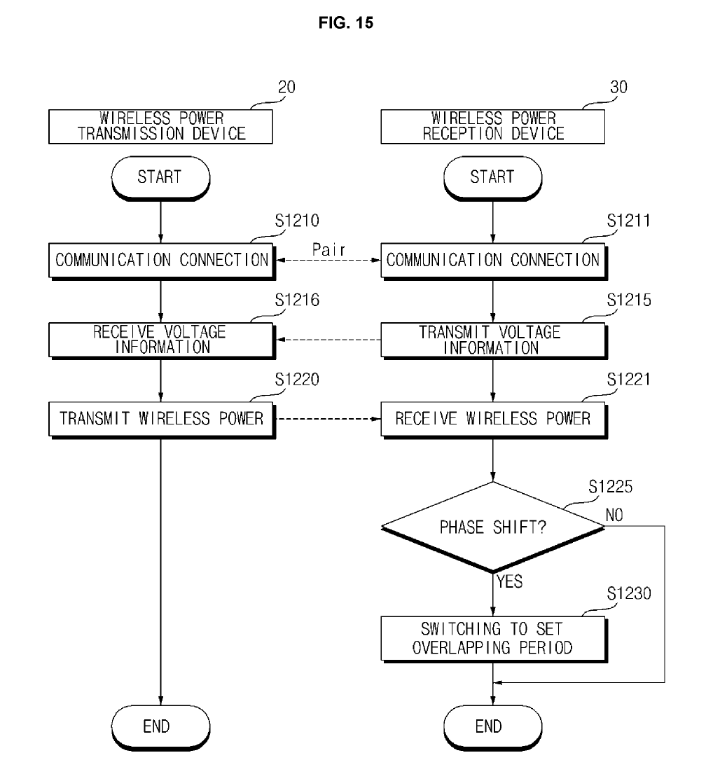

Next, FIG. 15 is an exemplary flowchart illustrating an operating method of a wireless power transmission device and a wireless power reception device according to an embodiment of the present disclosure. Referring to FIG. 15, the wireless power transmission device 20 can convert the input AC voltage Vac into a DC voltage can after being powered on and perform a communication connection with the wireless power reception device 30 based on the converted DC voltage (S1210). For example, the transceiver 716 of the wireless power transmission device 20 can connect to the transceiver 726 in the wireless power reception device 30 through a Bluetooth communication method and perform pairing.

The transceiver 726 in the wireless power reception device 30 can receive a connection request from the transceiver 716 of the wireless power transmission device 20 and perform a communication connection based on the connection request (S1211). That is, the transceiver 726 in the wireless power reception device 30 can receive a connection request from the transceiver 716 of the wireless power transmission device 20 and perform pairing based on the connection request.

In addition, the wireless power transmission device 20 can convert the input AC voltage Vac into a DC voltage after being powered on and perform wireless power transmission based on the converted DC voltage. In response, the wireless power reception device 30 can receive wireless power, output a first DC voltage Vrc based on the received power, convert the DC voltage based on the first DC voltage Vrc, and supply the converted DC voltage to each unit including the transceiver 726.

Further, the power supply 190 can detect the first DC voltage input to the dc/dc converter 910 through the input voltage detector DA or detect the display driving voltage Vdd output to the dc/dc converter 910 through the output voltage detector DD. Subsequently, the transceiver 726 in the wireless power reception device 30 can transmit voltage information to the transceiver 716 in the wireless power transmission device 20 (S1215).

In response, the transceiver 716 in the wireless power transmission device 20 can receive the voltage information from the transceiver 726 in the wireless power reception device 30 (S1216). The voltage information can be voltage information on the first DC voltage or voltage information on the display driving voltage. In addition, the processor 714 in the wireless power transmission device 20 can vary the wireless power and transmit the variable wireless power based on the voltage information on the first DC voltage or the voltage information on the display driving voltage (S1220).

In response, the wireless power reception device 30 can receive the variable wireless power (S1221). For example, the processor 714 in the wireless power reception device 30 can control the wireless power to be transmitted such that the wireless power decreases as the voltage information on the first DC voltage is equal to or greater than a first reference value and the difference from the first reference value increases. As another example, the processor 714 in the wireless power reception device 30 can control the wireless power to be transmitted such that the wireless power increases as the voltage information on the first DC voltage is less than the first reference value and the difference from the first reference value increases.

Further, the processor 714 in the wireless power reception device 30 can control the wireless power to be transmitted such that the wireless power decreases as the voltage information on the display driving voltage is equal to or greater than a second reference value and the difference from the second reference value increases. As another example, the processor 714 in the wireless power reception device 30 can control the wireless power to be transmitted such that the wireless power increases as the voltage information on the display driving voltage is less than the second reference value and the difference from the second reference value increases.

Subsequently, the dc/dc converter 910 in the power supply 190 can convert the first DC voltage output from the wireless power reception device 30 and output the display driving voltage Vdd. In addition, the controller 770 in the power supply 190 can determine whether operation in the phase shift mode of the dc/dc converter 910 is necessary (S1221), and if the operation in the phase shift mode is necessary, control the operation in the phase shift mode to be performed.

That is, the controller 770 in the power supply 190 can perform control such that a portion turn-on period of the first switching element S1 and the fourth switching element S4 among the plurality of switching elements S1 to S4 in the dc/dc converter 910 overlap in the phase shift mode (S1230). In particular, the controller 770 in the power supply 190 varies the overlapping portion in the turn-on period of the first switching element S1 and the fourth switching element S4 based on the level of the first DC voltage Vrc.

For example, the controller 770 in the power supply 190 can perform control such that the overlapping portion in the turn-on period of the first switching element S1 and the fourth switching element S4 becomes the first period when the first DC voltage Vrc is the first level, and perform control such that the overlapping portion in the turn-on period of the first switching element S1 and the fourth switching element S4 becomes the second period when the first DC voltage Vrc is the second level that is greater than the first level. Accordingly, it is possible to stably display an image according to wireless power transmission. In particular, it is possible to stably display an image in response to variation in the first DC voltage Vrc.

In step S1221, the controller 770 in the power supply 190 can change the switching frequency of the first to fourth switching elements S1 to S4, and in response to the switching frequency being equal to or higher than a reference frequency, operate phase shift mode. Further, the controller 770 in the power supply 190 can change the switching frequency of the first to fourth switching elements S1 to S4, and in response to the switching frequency being lower than the reference frequency, not operate the phase shift mode.

That is, the controller 770 in the power supply 190 can perform control such that the turn-on period of the first switching element S1 and the fourth switching element S4 completely overlap in response to the switching frequency being lower than the reference frequency. Accordingly, it is possible to stably display an image according to wireless power transmission.

In addition, the controller 770 in the power supply 190 can control the reference frequency such that the reference frequency increases as the level of the display driving voltage Vdd decreases. Accordingly, it is possible to stably display an image according to wireless power transmission. In particular, it is possible to display an image in response to variation in the level of the display driving voltage Vdd.

Alternatively, in step S1221, the controller 770 in the power supply 190 can control the first to fourth switching elements S1 to S4 to perform zero voltage switching, and when the first to fourth switching elements S1 to S4 do not perform zero voltage switching and thus the power consumed by the first to fourth switching elements S1 to S4 exceeds an allowable range, operate phase shift mode.

Further, the controller 770 in the power supply 190 can control the first to fourth switching elements S1 to S4 to perform zero voltage switching, and control the wireless power transmitted from the wireless power transmission device 20 to be changed based on the zero voltage switching. For example, if the first to fourth switching elements S1 to S4 do not perform zero voltage switching and thus the power consumed by the first to fourth switching elements S1 to S4 exceeds the allowable range, the transceiver 726 in the wireless power reception device 30 can transmit voltage information for varying the wireless power to the wireless power transmission device 20 through the transceiver 716 (S1215).

Accordingly, the wireless power transmission device 20 can vary the wireless power, and as a result, the first to fourth switching elements S1 to S4 can perform zero voltage switching based on the variable wireless power. In addition, the controller 770 in the power supply 190 according to another embodiment of the present disclosure performs a phase shift mode in response to variation in the first DC voltage Vrc output from the wireless power reception device 30, and, while operating in the phase shift mode, varies an overlapping portion during turn-on period of some switching elements S1 and S4 among the plurality of switching elements S1 to S4 in the dc/dc converter 910 based on the level of the first DC voltage Vrc. Accordingly, it is possible to stably display an image according to wireless power transmission. In particular, it is possible to stably display an image in response to variation in the DC voltage received from the wireless power reception device 30.

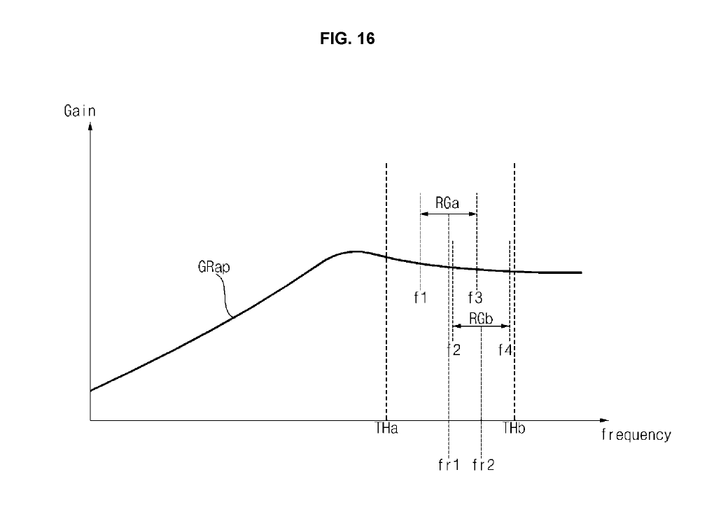

Next, FIG. 16 is a diagram referenced in description of FIG. 15. Specifically, FIG. 16 is a diagram illustrating gains corresponding to the operating frequencies of the plurality of switching elements S1 to S4 in the dc/dc converter 910.

Referring to FIG. 16, the controller 770 in the power supply 190 can change the switching frequency within a variable range THa to THb of the switching frequency based on the gain graph GRap with respect to the operating frequency. For example, THa can be approximately 100 KHz, and THb can be approximately 200 KHz.

In response to the switching frequency being less than the lower limit THa, the voltage gain of the dc/dc converter 910 is low, which is not desirable, and the switching frequency exceeding the upper limit THb is not desirable due to reduced efficiency and heat generation. Thus, the controller 770 in the power supply 190 can change the switching frequency of the first to fourth switching elements S1 to S4 within a first range, and operate phase shift mode in response to the switching frequency being equal to or higher than the reference frequency within the first range.

In addition, the controller 770 in the power supply 190 can change the first range or the reference frequency based on the display mode. For example, the controller 770 in the power supply 190 can control the first range or reference frequency to be greater in the display power control on mode corresponding to the first display mode than in the display power control off mode corresponding to the second display mode. Specifically, the controller 770 in the power supply 190 can set the first range RGa for switching frequency variation to f1 to f3 in the display power control off mode corresponding to the second display mode.

In addition, the controller 770 in the power supply 190 can operate phase shift mode if the switching frequency is equal to or higher than the reference frequency fr1 within the first range RGa in the display power control off mode corresponding to the second display mode. Accordingly, it is possible to stably display an image according to wireless power transmission. Further, the controller 770 in the power supply 190 cannot operate the phase shift mode if the switching frequency is less than the reference frequency fr1 within the first range RGa in the display power control off mode corresponding to the second display mode. That is, the controller 770 can perform an operation in the LCC mode in which turn-on period of the first switching element S1 and the fourth switching element S4 completely overlap.

Also, the controller 770 in the power supply 190 can set the first range RGb for switching frequency variation to f2 to f4 in the display power control on mode corresponding to the first display mode. Here, it is preferable that f2 be greater than f1 and f4 be greater than f3.

In addition, the controller 770 in the power supply 190 can operate phase shift mode, as described above, if the switching frequency is equal to or higher than the reference frequency fr2 within the first range RGb in the display power control on mode corresponding to the first display mode. Accordingly, it is possible to stably display an image according to wireless power transmission. Here, it is preferable that fr2 be greater than fr1.

Further, the controller 770 in the power supply 190 cannot operate the phase shift mode if the switching frequency is less than the reference frequency fr2 within the first range RGb in the display power control on mode corresponding to the first display mode. That is, the controller 770 can perform LCC mode.

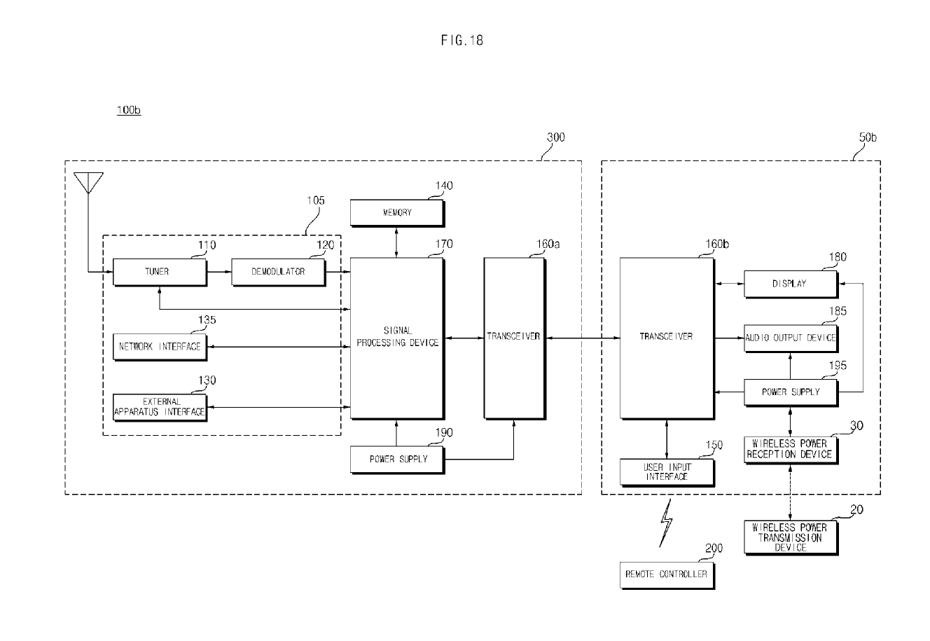

In addition, the controller 770 in the power supply 190 can turn off a power when the switching frequency of the first to fourth switching elements S1 to S4 is outside the first range RGa or RGb. Accordingly, it is possible to stably display an image according to wireless power transmission. Further, the wireless power transmission device 20190 can form magnetic fields for wireless power to the wireless power reception device 30, and control the strength of the magnetic field in the side regions (Area and Areb in FIG. 18) to be greater than that in the central region (ARct in FIG. 18). Accordingly, stable wireless power transmission can be performed.

Further, the transmission coil CLa in the wireless power transmission device 20 can include a central region core, an edge region core, a conductor wound around the central region core, and a conductor wound around the edge region core. Here, it is preferable that the height of the edge region core be greater than that of the central region core, and the length of the transmission coil CLa in the wireless power transmission device 20 be less than that of the display 180 and greater than half the length of the display 180.

In addition, the reception coil CLb in the wireless power reception device 30 can include a core, and a conductor wound around the core. It is preferable that the conductor wound around the core in the reception coil CLb be more densely packed in the side region than in the central region. Alternatively, it is preferable that the height of the core in the reception coil CLb be greater in the side region than in the central region.

In addition, it is preferable that the length of the reception coil CLb in the wireless power reception device 30 be less than the length of the display 180 and greater than half the length of the display 180. Accordingly, the strength of magnetic fields in the side region becomes greater than in the central region, and consequently, stable wireless power transmission can be performed based on the side region.

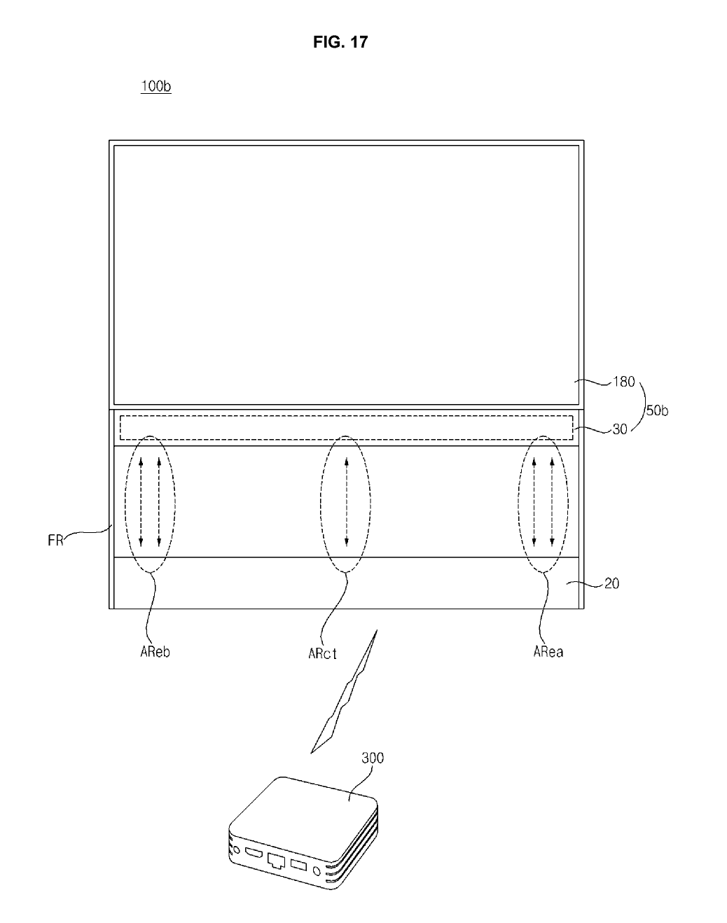

Next, FIG. 17 is a diagram illustrating an image display apparatus according to another embodiment of the present disclosure. Referring to FIG. 17, the image display apparatus 100b is similar to the image display apparatus 100 of FIG. 1, but differs in that the former additionally includes a wireless media device 300.

That is, the image display apparatus 100b according to another embodiment of the present disclosure includes the wireless power transmission device 20 that wirelessly transmits power, the wireless power reception device 30 that wirelessly receives power from the wireless power transmission device 20, the wireless media device 300 that wirelessly transmits an image signal or an audio signal without compressing the signal, and the display 180.

In FIG. 17, the wireless power transmission device 20 is disposed under the support frame FR, and the wireless power reception device 30 is disposed above the wireless power transmission device 20 and spaced apart from the wireless power transmission device 20. The wireless power transmission device 20 can be disposed under the display 180.

In addition, the wireless power transmission device 20 and the display 180 can be provided in a display device 50b, and the display device 50b can be supported by the support frame FR. Further, the wireless media device 300 is disposed spaced apart from the support frame FR.

When the wireless media device 300 transmits an image signal or an audio signal to the display device 50b without compressing the signal, the wireless media device 300 can transmit media data to the display device 50b using a frequency based on 60 GHz in order to secure a stable wireless bandwidth. For example, the wireless media device 300 in the image display apparatus 100b can transmit an image signal or an audio signal to the display device 50b through wireless communication based on the 802.11 ad/ay standard.

Next, FIG. 18 is a block diagram of the image display apparatus of FIG. 17. Referring to FIG. 18, the image display apparatus 100b includes the wireless media device 300, the display device 50b, and the wireless power transmission device 20 that wirelessly transmits power.

In addition, the wireless media device 300 can include an image receiver 105, a memory 140, a power supply 190, a signal processing device 170, and a transceiver 160a. The display device 50b can include a second transceiver 160b, a user input interface 150, a display 180, an audio output device 185, and a power supply 195. The display device 50b can further include the wireless power reception device 30 that wirelessly receives power from the wireless power transmission device 20.

Further, the transceiver 160a can perform wireless communication with the second transceiver 160b in the display device 50b. Also, the second transceiver 160b can perform wireless communication with the transceiver 160a in the wireless media device 300. An image signal and an audio signal received by the second transceiver 160b can be transmitted to the display 180 and the audio output device 185, respectively.

The operation of the wireless power transmission device 20 and the wireless power reception device 30 of FIGS. 17 and 18 can correspond to FIGS. 7 to 16. In addition, the operation of the dc/dc converter 910 in the power supply 190 in FIGS. 7 to 16 can correspond to the operation of a dc/dc converter in the power supply 195 in FIGS. 17 and 18.

As described above, an image display apparatus according to an embodiment of the present disclosure includes a wireless power transmission device configured to wirelessly transmit power, a wireless power reception device configured to receive wireless power from the wireless power transmission device, a dc/dc converter configured to convert a first DC voltage from the wireless power reception device and output a display driving voltage, a controller configured to control the dc/dc converter, and a display configured to operate based on the display driving voltage, wherein the dc/dc converter includes a first switching element and a second switching element connected in series with each other in a first leg, and a third switching element and a fourth switching element connected in series with each other in a second leg connected in parallel with the first leg, wherein the controller is configured to overlap a portion of turn-on period of the first switching element and the fourth switching element while operating in a phase shift mode, and change the overlapping portion in the turn-on period of the first switching element and the fourth switching element based on a level of the first DC voltage. Accordingly, it is possible to display images stably based on wireless power transmission. In particular, it is possible to display images stably in response to variation in the DC voltage received by the wireless power reception device.

In addition, the controller can control the first switching element and the second switching element to switch complementarily and the third switching element and the fourth switching element to switch complementarily. Accordingly, it is possible to display images stably based on wireless power transmission.

Further, the controller can, in response to the first DC voltage being at a first level, control the overlapping portion in the turn-on period of the first switching element and the fourth switching element to be a first period, and in response to the first DC voltage being at a second level higher than the first level, control the overlapping portion to be a second period less than the first period. Accordingly, it is possible to display images stably based on wireless power transmission. In particular, it is possible to display images stably in response to variation in the first DC voltage.

Also, the controller can increase the overlapping portion in the turn-on period of the first switching element and the fourth switching element as the level of the first DC voltage decreases while operating in the phase shift mode. Accordingly, it is possible to display images stably based on wireless power transmission. In particular, it is possible to display images stably in response to variation in the first DC voltage.

The controller can, in response to a level of the display driving voltage being a third level, control the overlapping portion in the turn-on period of the first switching element and the fourth switching element to be a third period, and control the overlapping portion in the turn-on period of the first switching element and the fourth switching element to be a fourth period greater than the third period in response to the level of the display driving voltage being a fourth level higher than the third level. Accordingly, it is possible to display images stably based on wireless power transmission. In particular, it is possible to display images stably in response to variation in the display driving voltage.

In addition, the controller can increase the overlapping portion in the turn-on period of the first switching element and the fourth switching element as the level of the display driving voltage increases. Accordingly, it is possible to display images stably based on wireless power transmission. In particular, it is possible to display images stably in response to variation in the display driving voltage.

Further, the controller can control the overlapping portion in the turn-on period of the first switching element and the fourth switching element to be a fifth period in response to a distance between the wireless power transmission device and the wireless power reception device being a first distance, and control the overlapping portion in the turn-on period of the first switching element and the fourth switching element to be a sixth period greater than the fifth period in response to the distance between the wireless power transmission device and the wireless power reception device being a second distance greater than the first distance. Accordingly, it is possible to display images stably based on wireless power transmission. In particular, it is possible to display images stably in response to variation in the distance between the wireless power transmission device and the wireless power reception device.

Also, the controller can increase the overlapping portion in the turn-on period of the first switching element and the fourth switching element as the distance between the wireless power transmission device and the wireless power reception device increases. Accordingly, it is possible to display images stably based on wireless power transmission. In particular, it is possible to display images stably in response to variation in the distance between the wireless power transmission device and the wireless power reception device.

The controller can operate the phase shift mode in response to the level of the first DC voltage being equal to or higher than a reference level, and in response to the level of the first DC voltage being lower than the reference level, control the turn-on period of the first switching element and the fourth switching element to completely overlap. Accordingly, it is possible to display images stably based on wireless power transmission. In particular, it is possible to display images stably in response to variation in the level of the first DC voltage.

The controller can change a switching frequency of the first switching element to the fourth switching element, operate the phase shift mode in response to the switching frequency being equal to or higher than a reference frequency, and in response to the switching frequency being lower than the reference frequency, control the turn-on period of the first switching element and the fourth switching element to completely overlap. Accordingly, it is possible to display images stably based on wireless power transmission.

In addition, the controller can increase the reference frequency as the level of the display driving voltage decreases. Accordingly, it is possible to display images stably based on wireless power transmission. In particular, it is possible to display images stably in response to variation in the level of the display driving voltage.

The controller can change the switching frequency of the first switching element to the fourth switching element within a first range, and operate the phase shift mode in response to the switching frequency being equal to or higher than a reference frequency within the first range. Accordingly, it is possible to display images stably based on wireless power transmission.

The controller can control the first switching element to the fourth switching element to perform zero voltage switching, and operate the phase shift mode while the first switching element to the fourth switching element performs the zero voltage switching. Accordingly, it is possible to display images stably based on wireless power transmission.

The controller can control the first switching element to the fourth switching element to perform zero voltage switching, and change wireless power transmitted from the wireless power transmission device based on the zero voltage switching. Accordingly, it is possible to display images stably based on wireless power transmission.

The controller can control a power to be turned off in response to the level of the first DC voltage being less than a lower limit level or exceeds an upper limit level. Accordingly, it is possible to display images stably based on wireless power transmission.

The image display apparatus according to an embodiment of the present disclosure can further include a signal processing device configured to output an image signal to the display, and the controller can output a first display driving voltage in response to an image output mode of the signal processing device being an eco mode or a standard mode, and output a second display driving voltage higher than the first display driving voltage in response to the image output mode of the signal processing device being a movie mode or a game mode. Accordingly, it is possible to display images stably based on wireless power transmission. In particular, it is possible to display images stably in response to variation in the level of the display driving voltage.

The controller can output a third display driving voltage higher than the second display driving voltage in response to the image output mode of the signal processing device being a high dynamic range mode. Accordingly, it is possible to display images stably based on wireless power transmission. In particular, it is possible to display images stably in response to variation in the level of the display driving voltage.

The wireless power transmission device can form magnetic fields for wireless power to the wireless power reception device and control strengths of the magnetic fields such that the strengths are greater in a side region than in a central area. Accordingly, it is possible to display images stably based on wireless power transmission.

In addition, the dc/dc converter can further include a transformer of which input terminal is connected to output terminals of the plurality of switching elements, and a rectifier disposed at the output terminal of the transformer. Accordingly, it is possible to display images stably based on wireless power transmission.

The dc/dc converter can further include a multi-level voltage output circuit connected to an output terminal of the rectifier and configured to output a plurality of display driving voltages based on a plurality of display modes. Accordingly, it is possible to display images stably based on wireless power transmission. In particular, it is possible to display images stably in response to variation in the level of the display driving voltage.

In accordance with another aspect of the present disclosure, the above and other objects can be accomplished by an image display apparatus including a wireless power transmission device configured to wirelessly transmit power, a wireless power reception device configured to wirelessly receive power from the wireless power transmission device, a dc/dc converter including a plurality of switching elements and configured to convert a first DC voltage from the wireless power reception device and output a display driving voltage, a controller configured to control the dc/dc converter, and a display configured to operate based on the display driving voltage, wherein the controller is configured to perform a phase shift mode in response to variation in the first DC voltage, and change an overlapping portion in turn-on period of some of the plurality of switching elements based on a level of the first DC current voltage while operating in the phase shift mode. Accordingly, it is possible to display images stably based on wireless power transmission. In particular, it is possible to display images stably in response to variation in the DC voltage received by the wireless power reception device.

While the disclosure has been described with reference to the embodiments, the disclosure is not limited to the above-described specific embodiments, and it will be understood by those skilled in the related art that various modifications and variations can be made without departing from the scope of the disclosure as defined by the appended claims, as well as these modifications and variations should not be understood separately from the technical spirit and prospect of the disclosure.

What is claimed is:

1. An image display apparatus comprising:
a wireless power transmission device configured to wirelessly transmit power;
a wireless power reception device configured to receive wireless power from the wireless power transmission device;
a dc/dc converter configured to convert a first DC voltage from the wireless power reception device and output a display driving voltage;
a controller configured to control the dc/dc converter; and
a display configured to operate based on the display driving voltage,
wherein the dc/dc converter comprises:
a first switching element and a second switching element connected in series with each other in a first leg; and
a third switching element and a fourth switching element connected in series with each other in a second leg connected in parallel with the first leg, and
wherein the controller is configured to:
operate in a phase shift mode and turn on the first switching element and the fourth switching element in an overlapping turn-on period, and
increase or decrease the overlapping turn-on period of the first switching element and the fourth switching element based on a level of the first DC voltage.

2. The image display apparatus of claim 1, wherein the controller is configured to:
in response to the first DC voltage being at a first level, control the overlapping turn-on period of the first switching element and the fourth switching element to be a first period, and
in response to the first DC voltage being at a second level higher than the first level, control the overlapping turn-on period of the first switching element and the fourth switching element to be a second period less than the first period.

3. The image display apparatus of claim 1, wherein the controller is configured to increase the overlapping turn-on period of the first switching element and the fourth switching element as the level of the first DC voltage decreases while operating in the phase shift mode.

4. The image display apparatus of claim 1, wherein the controller is configured to:
in response to a level of the display driving voltage being a third level higher than the second level, control the overlapping turn-on period of the first switching element and the fourth switching element to be a third period, and
in response to the level of the display driving voltage being a fourth level higher than the third level, control the overlapping turn-on period of the first switching element and the fourth switching element to be a fourth period greater than the third period.

5. The image display apparatus of claim 1, wherein the controller is configured to increase the overlapping turn-on period of the first switching element and the fourth switching element as the level of the display driving voltage increases.

6. The image display apparatus of claim 1, wherein the controller is configured to:
in response to a distance between the wireless power transmission device and the wireless power reception device being a first distance, control the overlapping turn-on period of the first switching element and the fourth switching element to be a fifth period, and
in response to the distance between the wireless power transmission device and the wireless power reception device being a second distance greater than the first distance, control the overlapping turn-on period of the first switching element and the fourth switching element to be a sixth period greater than the fifth period.

7. The image display apparatus of claim 1, wherein the controller is configured to increase the overlapping turn-on period of the first switching element and the fourth switching element as the distance between the wireless power transmission device and the wireless power reception device increases.

8. The image display apparatus of claim 1, wherein the controller is configured to:
in response to the level of the first DC voltage being equal to or higher than a reference level, maintain operating in the phase shift mode, and
in response to the level of the first DC voltage being lower than the reference level, control the overlapping turn-on period of the first switching element and the fourth switching element to completely overlap.

9. The image display apparatus of claim 1, wherein the controller is configured to:
change a switching frequency of the first switching element to the fourth switching element,
in response to the switching frequency being equal to or higher than a reference frequency, maintain operation of the phase shift mode, and
in response to the switching frequency being lower than the reference frequency, control the overlapping turn-on period of the first switching element and the fourth switching element to completely overlap.

10. The image display apparatus of claim 9, wherein the controller is configured to increase the reference frequency as the level of the display driving voltage decreases.

11. The image display apparatus of claim 1, wherein the controller is configured to:
change the switching frequency of the first switching element to the fourth switching element within a first range, and
in response to the switching frequency being equal to or higher than a reference frequency, maintain operation of the phase shift mode within the first range.

12. The image display apparatus of claim 1, wherein the controller is configured to control the first switching element to the fourth switching element to perform zero voltage switching, and maintain operation of the phase shift mode while the first switching element to the fourth switching element performs the zero voltage switching.

13. The image display apparatus of claim 12, wherein the controller is configured to control the first switching element to the fourth switching element to perform zero voltage switching, and change wireless power transmitted from the wireless power transmission device based on the zero voltage switching.

14. The image display apparatus of claim 1, wherein the controller is configured to control a power to be turned off in response to the level of the first DC voltage being less than a lower limit level or exceeds an upper limit level.

15. The image display apparatus of claim 1, further comprising a signal processing device configured to output an image signal to the display,
wherein the controller is configured to:
output a first display driving voltage in response to an image output mode of the signal processing device being an eco mode or a standard mode, and
output a second display driving voltage higher than the first display driving voltage in response to the image output mode of the signal processing device being a movie mode or a game mode.

16. The image display apparatus of claim 15, wherein the controller is configured to output a third display driving voltage higher than the second display driving voltage in response to the image output mode of the signal processing device being a high dynamic range mode.

17. The image display apparatus of claim 1, wherein the dc/dc converter further comprises:
a transformer of which input terminal is connected to output terminals of the plurality of switching elements; and
a rectifier disposed at the output terminal of the transformer.

18. The image display apparatus of claim 17, wherein the dc/dc converter further comprises a multi-level voltage output circuit connected to an output terminal of the rectifier and configured to output a plurality of display driving voltages based on a plurality of display modes.

19. An image display apparatus comprising:
a wireless power transmission device configured to wirelessly transmit power;
a wireless power reception device configured to wirelessly receive power from the wireless power transmission device;
a dc/dc converter including a plurality of switching elements and configured to convert a first DC voltage from the wireless power reception device and output a display driving voltage;
a controller configured to control the dc/dc converter; and
a display configured to operate based on the display driving voltage,
wherein the controller is configured to:
perform a phase shift mode in response to variation in the first DC voltage, and
change an overlapping portion in a turn-on period of some of the plurality of switching elements based on a level of the first DC current voltage while operating in the phase shift mode.

20. The image display apparatus of claim 19, wherein the controller increases or decreases the overlapping portion based on the level of the first DC current voltage.
